(19) United States
(12) Patent Application Publication
(10) Pub. No.: US 2016/0171417 A1
(43) Pub. Date: Jun. 16, 2016

(54) SYSTEMS AND METHODS FOR OPERATING AND MANAGING ENTERPRISE SYSTEMS ON A MOBILE ELECTRONIC DEVICE TO MEASURE EFFICIENCY AND PRODUCTIVITY OF MOBILE ELECTRONIC DEVICE OPERATORS

(71) Applicant: Smart Gladiator LLC, Duluth, GA (US)

(72) Inventor: Pugazhenthi Sankaralingham, Duluth, GA (US)

(21) Appl. No.: 15/048,443

(22) Filed: Feb. 19, 2016

Related U.S. Application Data
(63) Continuation-in-part of application No. 14/293,313, filed on Jun. 2, 2014.
(60) Provisional application No. 61/833,358, filed on Jun. 10, 2013.

(51) Int. Cl. G06Q 10/06; G06F 3/0484; G06Q 10/08; G06F 3/0488

(52) U.S. Cl. CPC G06Q 10/06398; G06F 3/04886; G06F 3/04847; G06Q 10/087

(57) ABSTRACT

The present disclosure provides methods and apparatuses operable to manage an enterprise system via a mobile electronic device. The mobile electronic device can include a touch screen display, a transceiver, and one or more processors. The transceiver can be in bi-directional wireless communication with an enterprise system running on a remote computer system. The one or more processors can provide a user interface for display on the touch screen display via a terminal emulation application executing on the one or more processors. The user interface can include first content received via the transceiver from the enterprise system running on the remote computer system. The user interface can include second content including a productivity count. The user interface can include a see through touch sensitive button superimposed in a semi-transparent manner over the first content.

### CROSS-REFERENCE TO RELATED APPLICATION

The present application claims priority under 35 U.S.C. §120 as a continuation-in-part to U.S. patent application Ser. No. 14/293,313, filed Jun. 2, 2014, and entitled “SYSTEMS AND METHODS FOR OPERATING AND MANAGING ENTERPRISE SYSTEMS ON A MOBILE ELECTRONIC DEVICE,” which claims priority under 35 U.S.C. §119 to U.S. Provisional Patent Application No. 61/833,358, filed Jun. 10, 2013 and entitled “SYSTEMS AND METHODS FOR OPERATING AND MANAGING ENTERPRISE SYSTEMS ON A MOBILE ELECTRONIC DEVICE,” each of which are incorporated herein by reference in its entirety.

### TECHNICAL FIELD

The present application relates generally to the field of enterprise systems. More specifically, the present application relates to systems for remotely controlling and managing enterprise systems for inventory management.

### BACKGROUND

Warehouse, distribution center, and fulfillment center operators use wearable computers to perform tasks within their operations. These wearable computers are generally worn by operators in the arms or hips while performing operations like loading, unloading, picking, location inventory. These wearable computers provide mobility to operators while simultaneously providing real-time connectivity with inventory control systems for increasing the accuracy and efficiency of their operations. However, these wearable computers have disadvantages associated with their weight, and user interface. Additionally, these devices lack adaptability and configurability across a variety of platforms and back end systems making them expensive to purchase and upgrade or use across multiple industries. Furthermore, displaying user interfaces for optimal use by the operator of the device may arise, due to the relatively small size of wearable computers.

The inventory in warehouses, distribution centers, and fulfillment centers has financial value and is reflected as an asset in the firm's balance sheet. The accuracy of the inventory level is very critical for the firm carrying the inventory as it impacts the order fill rate of the firm and revenue. For at least these reasons, warehouse operators routinely count inventory in locations using wearable computer devices to track the manually counted inventory in a location. This inventory count takes valuable labor out of receiving and shipping operations in the warehouse and makes inventory management, onerous, labor intensive, inefficient, and at times unreliable.

Additionally, warehouse managers are tasked with managing their labor efficiently and reducing unproductive labor time. Operations management systems may be used to calculate operator productivity, which may be used to incentivize highly productive operators. The amount of distance user travels within the warehouse as part of their operations is a major factor in determining operator productivity. The current operations management systems face difficult challenges related to accurately locating a user in the warehouse and calculating the distance a user travelled. Current systems use the X, Y, and Z coordinates tied to the locations scanned by the user to calculate the distance travelled. Often users scan locations before they even physically arrive at the location to boost their productivity and game the system.

### SUMMARY

The inventors have appreciated that implementation of inventive applications on readily available consumer products provides lightweight, reliable, and easily configurable systems for a variety of enterprise applications. Additionally, these systems may be implemented in inventive ways to increase efficiency and accuracy of inventory management and operations management. For example, gamification techniques may be adapted to increase work performance and to determine whether work performance satisfies specified objectives. In view of the foregoing, the present disclosure is directed to methods and apparatuses operable to provide terminal emulation on mobile electronic devices, inventory management via mobile electronic devices, and operations management via mobile electronic devices.

In one aspect, a mobile electronic device for terminal emulation is provided. The mobile electronic device can include a touch screen display, a transmitter configured for bi-directional wireless communication, and a processor configured to provide a user interface to the mobile electronic device, wherein the mobile electronic device connects, via the transmitter, to at least one computer system remote from the mobile electronic device, the processor further configured to cause display of a see through touch sensitive buttons on the touch screen display, wherein the see through touch sensitive buttons is superimposed on content displayed on the touch screen display. The mobile electronic device further can include a harness removably coupled to the mobile electronic device.

In various embodiments the user interface can include at least one of a telnet, a ssl, a ssh, a http and a https user interface.

The mobile electronic device may include an image capture device. The mobile electronic device may include a video capture device. In accordance with various embodiments the processor is further configured to upload at least one of an image obtained by the image capture device to a transfer protocol server.

A scanner may be coupled to the mobile electronic device. The scanner may include a bar code scanner. The scanner may include a ring scanner.

In various embodiments, the at least one computer system can include an inventory management system.

The see through touch sensitive buttons may include at least one of an alpha, numeric, function and cursor key keyboard in accordance with various embodiments.

The keys of see through touch sensitive buttons may be configured in response to a selected function.

In various embodiments the mobile electronic device can include an RFID reader.

In another aspect, a method for emulating a terminal on a mobile electronic device is provided. The method can include providing a user interface to the mobile electronic device, whereby the mobile electronic device can be configured for wirelessly connecting to at least one computer system. The method further can include causing, on a touch screen display of the mobile electronic device, via at least one processor of the mobile electronic device, a display of a see through touch sensitive buttons on the touch screen display, wherein the see through touch sensitive buttons is superimposed on content displayed on the touch screen display.

The user interface may include at least one of a telnet, a ssl, a ssh, a http and a https user interface in accordance with various embodiments.

In various embodiments, the method can include configuring, via the at least processor, a connection protocol for wirelessly connecting to the at least one computer.

The method may include reading, via the at least one processor, at least one return parameter transmitted from the at least one computer to the mobile electronic device.

In various embodiments, the method can include electronically coupling the mobile electronic device with a barcode scanner.

In another aspect, a system for emulating a terminal on a mobile electronic device is provided. The system can include a user interface engine configured to wirelessly connect the mobile electronic device to at least one computer system. The system also can include a see through touch sensitive buttons generator configured to cause on a touch screen display of the mobile electronic device, via at least one processor of the mobile electronic device, a display of a see through touch sensitive buttons on the touch screen display, wherein the see through touch sensitive buttons is superimposed on content displayed on the touch screen display.

In various embodiments, the user interface engine can be configured to wirelessly connect the mobile electronic device to at least one computer system via at least one of a telnet, a ssl, a ssh, a http, and a https.

The system may include an RFID reader, wherein the RFID reader configured to transmit a message to the at least one computer system in response to receipt of a detected RFID signal.

The system may include a monitoring module configured to store device handling information. The monitoring module may store the location of the device based on GPS data. The monitoring module may store information in response to activation of the telnet user interface.

In another aspect, a system for configuring a mobile device for enterprise use is provided. The system can include an application disabling engine. The application disabling engine can be configured to disable one or more applications running on the device, the one or more application selected from the group consisting of an internet browser, a gaming application and a music player. The system also can include an installation module configured to download an enterprise application on the mobile device. The enterprise application can include a user interface engine configured to wirelessly connect the mobile electronic device to at least one computer system, and a see through touch sensitive buttons generator configured to cause on a touch screen display of the mobile electronic device, via at least one processor of the mobile electronic device, a display of a see through touch sensitive buttons on the touch screen display, wherein the see through touch sensitive buttons is superimposed on content displayed on the touch screen display. The system also can include an identification requester configured to obtain a user identification and a user password. The system further can include an application restrictor, the application restrictor configured to restrict at least one communication application installed on the device to operation with at least one user from a pre-defined user group.

The user interface engine of the system may be configured to wirelessly connect the mobile electronic device to at least one computer system via at least one of a telnet, a ssl, a ssh, a http, and a https.

In another aspect, an inventory management system is provided. The inventory management system can include a user interface engine configured to wirelessly connect a mobile electronic device to at least one computer system, a see through touch sensitive buttons generator configured to cause on a touch screen display of the mobile electronic device, via at least one processor of the mobile electronic device, a display of a see through touch sensitive buttons on the touch screen display, wherein the see through touch sensitive buttons is superimposed on content displayed on the touch screen display, and an image retriever, configured to facilitate selection of an inventory item from an inventory image database and cause display of an image of a selected inventory item on the touch screen display.

In accordance with various embodiments of the inventory management system, the user interface engine can be configured to wirelessly connect the mobile electronic device to at least one computer system via at least one of a telnet, a ssl, a ssh, a http, and a https.

In another aspect, a voice enabled inventory management system is provided. The system can include a user interface engine configured to wirelessly connect a mobile electronic device to at least one computer system. The system also can include a see through touch sensitive buttons generator configured to cause on a touch screen display of the mobile electronic device, via at least one processor of the mobile electronic device, a display of a see through touch sensitive buttons on the touch screen display, wherein the see through touch sensitive buttons is superimposed on content displayed on the touch screen display. The system further can include a voice interface controller configured to convert commands received from the at least one computer system to voice prompts, the voice prompts transmitted via an audio component of the mobile electronic device, the voice interface controller further configured to obtain voice commands via a microphone component of the mobile electronic device and convert the voice commands to text for transmission to the at least one computer system via the telnet user interface.

The user interface engine of the voice enabled inventory management may be configured to wirelessly connect the mobile electronic device to at least one computer system via at least one of a telnet, a ssl, a ssh, a http, and a https.

In another aspect, a mobile electronic device for terminal emulation is provided. The mobile electronic device can include a touch screen display, a transceiver, and one or more processors. The transceiver can be in bi-directional wireless communication with an enterprise system running on a remote computer system. The one or more processors can provide a user interface for display on the touch screen display via a terminal emulation application executing on the one or more processors. The user interface can include first content received via the transceiver from the enterprise system running on the remote computer system. The user interface can include second content including a productivity count. The user interface can include a see through touch sensitive button superimposed in a semi-transparent manner over the first content. The see through touch sensitive button can provide a touch-sensitive key to send data to the remote computer responsive to activation while simultaneously continuing to display the first content received from the remote computer system on the touch screen display.

In various embodiments, the mobile electronic device can further include a capture device coupled to the one or more processors that detects or scans an object. The capture device can include at least one of a scanner, an image capture device, a video capture device, or a RFID reader. In various embodiments, the one or more processors can maintain a productivity counter updating the productivity count, responsive to the capture device detecting or scanning the object.

In various embodiments, the transceiver can transmit the productivity count to the remote computer system for storage at a predefined time interval. In various embodiments, the transceiver can be in further bi-directional wireless communication with a computing device and transmits at a predefined time interval the productivity count to the computing device, causing the computing device to display the productivity count.

In various embodiments, the user interface can further include an initiation dialog prompting an entry of an assignment identifier. Entry of the assignment identifier can cause the one or more processors to start a tracking session to update the productivity count. In various embodiments, the user interface can further include a terminal dialog including a second touch-sensitive key. Activation of the second touch-sensitive key can cause the one or more processors to end the tracking session.

In various embodiments, the one or more processors can maintain the productivity count categorized by a time interval, an assignment identifier, and an operator identifier. In various embodiments, the productivity count can include at least one of units per hour, total units reported, and a total time elapsed.

In another aspect, a system for terminal emulation is provided. The system can include a terminal emulation application executing on one or more processors of a mobile electronic device, a productivity counter executing on the one or more processors of the mobile electronic device, a control button generator executing on the one or more processors of the mobile electronic device, and an user interface engine executing on the one or more processors of the mobile electronic device. The terminal emulation application can receive via a transceiver first content from an enterprise system running on a remote computer system. The productivity counter can maintain second content including a productivity count. The control button generator can generate a see through touch sensitive button for operating with the terminal emulation application. The user interface engine can display a user interface on a touch screen display of the mobile electronic device. The user interface can include the first content received by the terminal emulation application. The user interface can include the second content including the productivity count maintained by the productivity counter. The user interface can include the see through touch sensitive button superimposed in a semi-transparent manner over the first content. The see through touch sensitive button can provide a touch-sensitive key, the see through touch sensitive button providing a touch-sensitive key to send sending data to the remote computer system responsive to activation while simultaneously continuing to display the first content received from the remote computer system on the touch screen display.

In various embodiments, the productivity counter can initiate the maintenance of the productivity count, responsive to an initiation command from a first activation of the user interface. In various embodiments, the productivity counter can reset the productivity count, responsive to a termination command from a second activation of the user interface.

In various embodiments, the productivity counter can maintain a session timer to count a session time duration between receipt the initiation command and receipt of the termination command. In various embodiments, the productivity counter can maintain a session timer to count a session time duration between receipt the initiation command and receipt of the termination command. In various embodiments, the productivity counter can transmit via the transceiver the productivity count to a computing device or the remote computer system, responsive to a request from the computing device. In various embodiments, the productivity count can include at least one of units per hour, total units reported, and a total time elapsed.

In another aspect, a system for configuring a mobile device for enterprise use is provided. The system can include an enterprise application executing on a remote computer system having one or more processors, an operations management module executing on the remote computer system, and an installation module executing on the remote computer system. The enterprise system can maintain an inventory count. The operations management module can maintain a server-side productivity count in a database. The installation module can transmit a terminal emulation application for installation at a mobile electronic device. The terminal emulation application can cause the mobile electronics device to display a user interface. The user interface can include first content received from the remote computing system, including an emulated version of the enterprise application. The user interface can include second content including a client-side productivity count maintained by the mobile electronic device. The user interface can include a see through touch sensitive button superimposed in a semi-transparent manner over the first content. The see through touch sensitive button can provide a touch-sensitive key to send data to the remote computer system responsive to activation while simultaneously continuing to display the first content received from the remote computer system on the touch screen display.

In various embodiments, the operations management module can receive the client-side productivity count from the mobile electronic device at a predefined time interval. In various embodiments, the operations management module can set the server-side productivity count to the client-side productivity count, responsive to receiving the client-side productivity count.

In various embodiments, the operations management module can maintain the server-side productivity count categorized by a time interval, an assignment identifier, and an operator identifier. In various embodiments, the operations management module can transmit the server-side productivity count categorized by the time interval, the assignment identifier, and the operator identifier to a computing device, receipt of the server-side productivity count causing the computing device to display the server-side productivity count thereon.

In various embodiments, the operations management module can transmit the server-side productivity count and an operator identifier corresponding to the mobile electronic device to a computing device. Receipt of the server-side productivity count can cause the computing device to calculate a productivity metric based on the server-side productivity count for the operator identifier. Receipt of the server-side productivity count can cause the computing device to display the productivity metric, responsive to calculating the productivity metric.

In various embodiments, the enterprise application can update the inventory count, responsive to receiving a client-side inventory count from the mobile electronic device. In various embodiments, the server-side productivity count can include at least one of units per hour, total units reported, and a total time elapsed.

In various embodiments, the operations management module can receive the client-side productivity count from the mobile electronic device. In various embodiments, the operations management module can compare the client-side productivity count to an average client-side productivity count calculated over a plurality of client-side productivity counts. In various embodiments, the operations management module can transmit an alert indicator to the mobile electronic device or a computing device, responsive to determining that the client-side productivity count is below the average client-side productivity count by a predetermined threshold.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawing primarily is for illustrative purposes and is not intended to limit the scope of the inventive subject matter described herein. The drawing is not necessarily to scale; in some instances, various aspects of the inventive subject matter disclosed herein may be shown exaggerated or enlarged in the drawings to facilitate an understanding of different features. In the drawing, like reference characters generally refer to like features (e.g., functionally similar and/or structurally similar elements).

FIG. 1 is a diagram illustrating a terminal emulation system in accordance with illustrative embodiments.

FIG. 2 shows a mobile electronic device for implementing the terminal emulation system of FIG. 1.

FIG. 3 illustrates another mobile electronic device embodiment for implementing the terminal emulation system of FIG. 1

FIGS. 4A-4C illustrate a wearable sleeve for holding a mobile electronic device implemented for terminal emulation on an operators arm in accordance with illustrative embodiments.

FIG. 5 shows a case for increasing impact resistance and durability of a mobile electronic device implemented for terminal emulation in accordance with illustrative embodiments.

FIG. 6A illustrates a display of a device, such as an iPod touch, having a terminal emulation application in accordance with illustrative embodiments installed thereon.

FIG. 6B provides a screen shot of an initiation screen displayed on a mobile device at the start of a terminal emulation session in accordance with illustrative embodiments.

FIGS. 7A and 7B show screenshots of the connection screens displayed on a mobile device at the start of a terminal emulation session in accordance with illustrative embodiments.

FIG. 8 illustrates a screen shot of the emulated terminal as displayed on the mobile device upon connection to a remote computer terminal in accordance with illustrative embodiments.

FIGS. 9A-9I illustrate screenshots of various configuration parameters selectable via a mobile electronic device in connection with connecting to the remote computer terminal in accordance with illustrative embodiments.

FIGS. 10A-10D show screenshots of various settings selectable via a mobile electronic device in connection with connecting to the remote computer terminal in accordance with illustrative embodiments.

FIG. 11A-11C illustrates a screen shot of a mobile device operable to disconnect from the remote computer terminal in accordance with illustrative embodiments.

FIG. 12 illustrates a soft-overlay cursor keyboard displayable on a mobile device in connection with connecting the mobile device to the remote computer terminal in accordance with illustrative embodiments.

FIG. 13 illustrates a soft-overlay alpha keyboard displayable on a mobile device in connection with connecting the mobile device to a remote computer terminal in accordance with illustrative embodiments.

FIG. 14 illustrates a soft-overlay function keyboard displayable on a mobile device in connection with connecting the mobile device to a remote computer terminal in accordance with illustrative embodiments.

FIG. 15 illustrates a soft-overlay numeric keyboard displayable on a mobile device in connection with connecting the mobile device to a remote computer terminal in accordance with illustrative embodiments.

FIG. 16A illustrates a QWERTY keyboard of a mobile device being displayed during a terminal emulation session on the mobile device to the remote computer terminal in accordance with illustrative embodiments.

FIGS. 16B-16F illustrate a personal keyboard configurable and displayed during a terminal emulation session on the mobile device in accordance with illustrative embodiments.

FIGS. 17A-17E depict screenshots of uploader system transitioning through various processes in accordance with illustrative embodiments.

FIG. 18 provides a flow diagram for inventory count by image system in accordance with illustrative embodiments.

FIGS. 19A-19C provides a schematic diagram of an inventory count by image system in accordance with illustrative embodiments.

FIG. 20 provides a screen shot of an operations management system implemented in accordance with illustrative embodiments.

FIGS. 21-22 provides a screen shot of an uploader application implemented in accordance with illustrative embodiments.

FIG. 23 illustrates a management console application that may be used to configure the other application disclosed herein in accordance with illustrative embodiments.

FIGS. 24A-24K illustrate screenshots of the management console application of FIG. 23 in accordance with illustrative embodiments.

FIG. 25 illustrates a screenshot of the management console application that may be used to configure an inventory capture session in accordance with inventive embodiments.

FIGS. 26A-F illustrate screenshots of inventory capture session interfaces displayed during a terminal emulation session on the mobile device to the remote computer terminal in accordance with illustrative embodiments.

FIGS. 27A-E illustrate screenshots of productivity rate tracking interfaces displayed on another mobile device communicatively interfaced with the remote computer terminal, in accordance with illustrative embodiments.

The features and advantages of the inventive concepts disclosed herein will become more apparent from the detailed description set forth below when taken in conjunction with the drawings.

### DETAILED DESCRIPTION

Following below are more detailed descriptions of various concepts related to, and embodiments of, inventive systems, methods and apparatus for protecting a source of visual information and particularly electronic sources of visual information. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

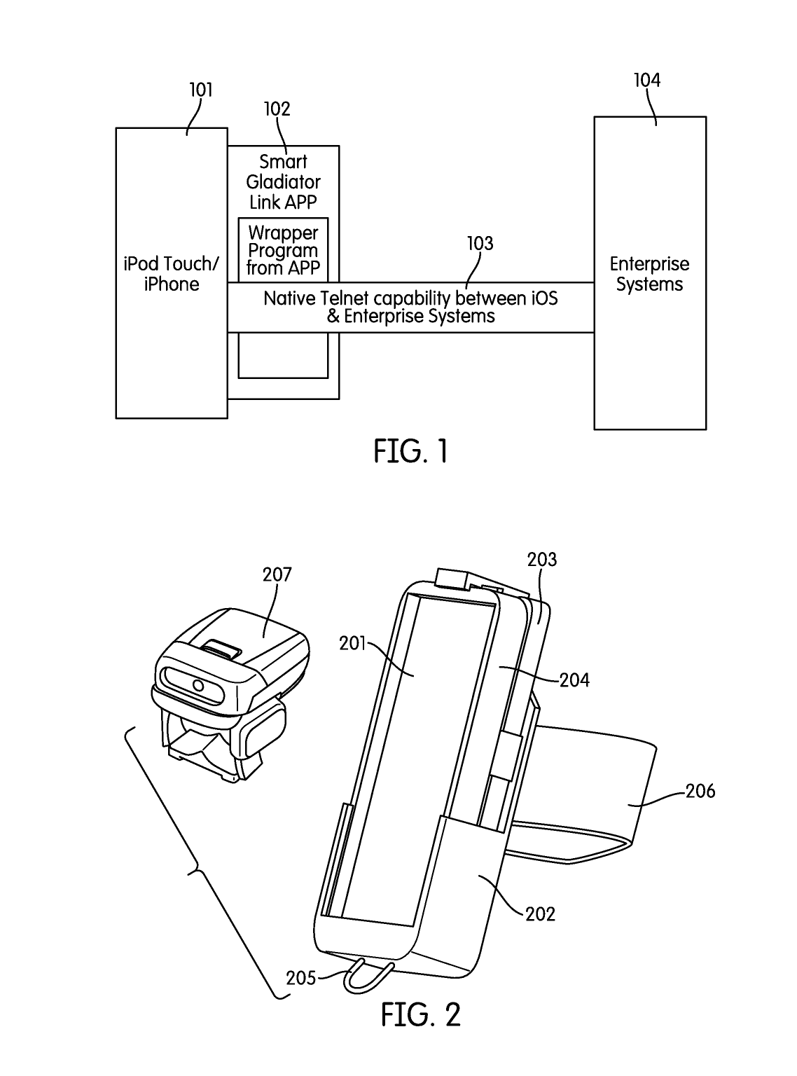

FIG. 1 is a diagram illustrating a terminal emulation system in accordance with illustrative embodiments. A mobile electronic device 101 may include one or more memory storage to store computer-readable instructions and one or more processors to execute the stored computer-readable instructions. The mobile electronic device 101 may also include one or more input and output devices, such as a touchscreen display, a transceiver, or a data acquisition device. The mobile electronic device 101, such as an iPod Touch may be implemented in accordance with exemplary embodiments for hosting a terminal emulator application on device 101. Mobile electronic device 101 may be configured, for example by downloading an application from an online application store, to run an application 102 that provides a user interface on device 101 for establishing, via a wireless communication interface, a telnet or ssl or ssh or http or https connection 103 or network protocol with a remote computer or server 104 running a backend system. In various embodiments, mobile electronic device 101 may include a mobile operating system including, but not limited to, Android, iOS, Windows mobile, WebOS, or another mobile operating system. Once received via the transceiver, the mobile electronic device 101 may execute the application 102 on the one or more processors. The mobile electronic device 101 may receive inputs for the application 102 via the touchscreen display. In various embodiments, the mobile electronic device 101 may receive inputs for the application 102 via the data acquisition device (e.g., scanner, camera, or RFID reader) communicatively connected or coupled with the mobile electronic device 102. Responsive to processing the inputs using the application 102, the mobile electronic device 101 may display an output of the application 102 on the touchscreen display.

Depending on the operating system running on mobile electronic device, the terminal emulator application may include, but is not limited to, an iOS application or a Java application. Remote computer 104 may include a mid-range computer, such as an IBM AS/400 or other enterprise systems, a mainframe computer, UNIX based server computer, a personal computer, a cloud computing system, a MAC, etc. The telnet or ssl or ssh or http or https connection 103 may be implemented via a network such as the internet or a local area network to provide bi-direction interactive text-oriented communication between device 101 and computer 104. The backend system running on remote computer 104 may include enterprise systems including, but not limited to, enterprise resource planning (ERP) systems, inventory control or management systems, transportation management systems, retail point of sale systems, retail inventory merchandising systems, a rental car-check-in/check-out systems, or restaurant order taking systems. The terminal emulator application may display an emulated version of the graphical user interface of the backend system running on the remote computer 104. The terminal emulator application may communicate code, data, and packets, among others, with the remote computer 104 via the transceiver.

In various embodiments, the application 102 may also include the terminal emulator application, a productivity counter, a control button generator, and a user interface engine. Each of the terminal emulator application, the productivity counter, the control button generator, and the user interface engine may execute, operate, or otherwise run on the one or more processors of the mobile electronic device 101. Each of the terminal emulator application, the productivity counter, the control button generator, and the user interface engine may be implemented in software or hardware, or any combination thereof.

The terminal emulator application may be downloaded by the mobile electronic device 101 from the remote computer 104 and installed on the mobile electronic device 101. The terminal emulator application may display an emulated version of the graphical user interface of the backend system running on the remote computer 104 using, for example, an echo function to transmit, receive, and send data from the remote computer 104.

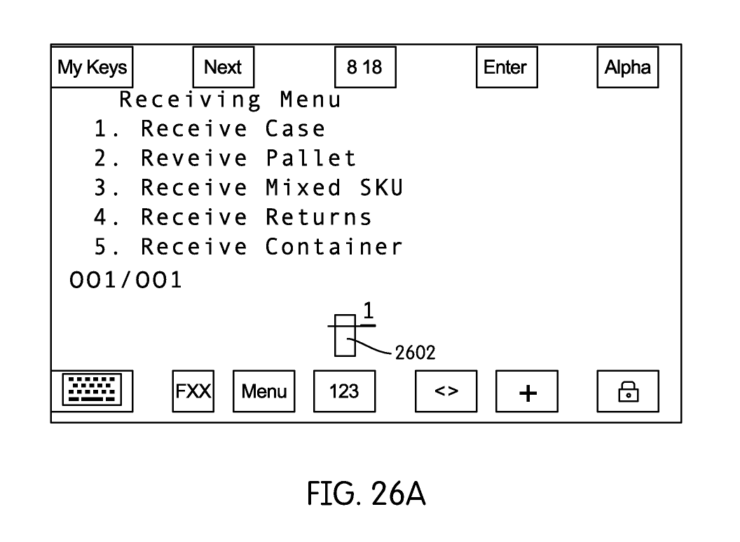

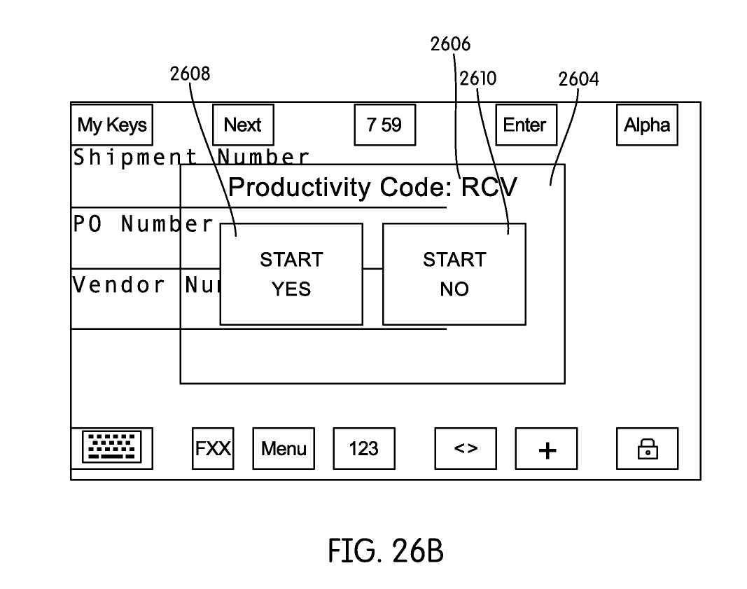

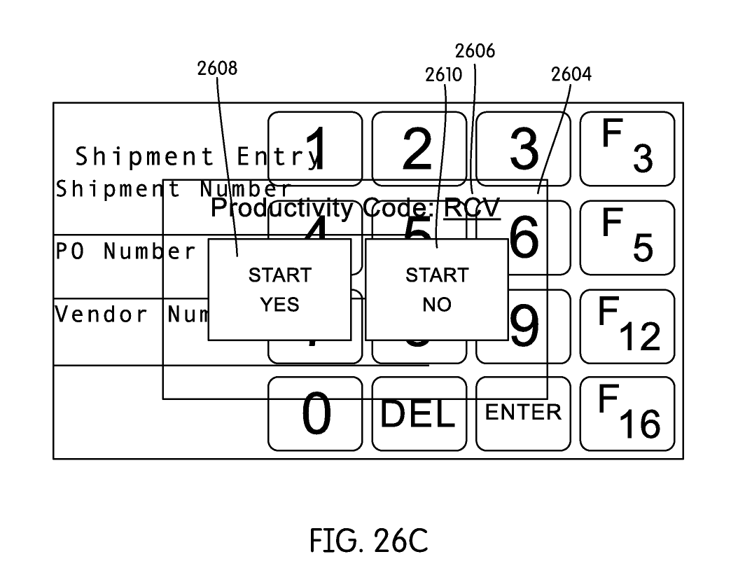

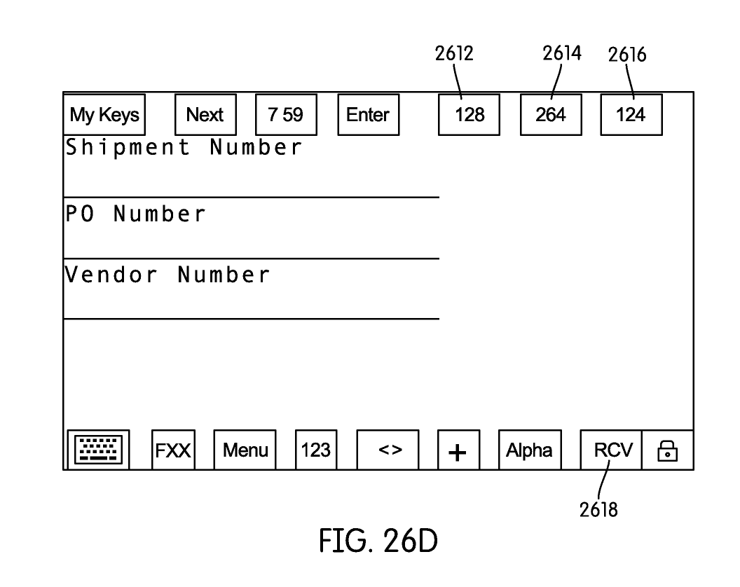

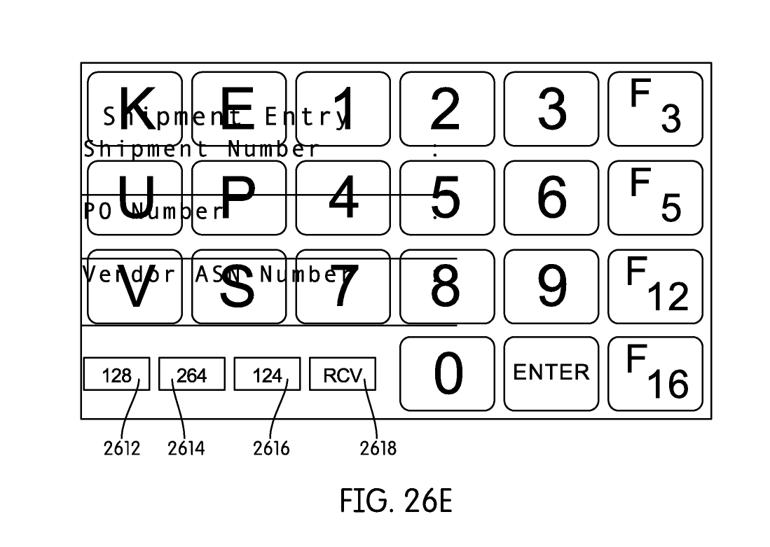

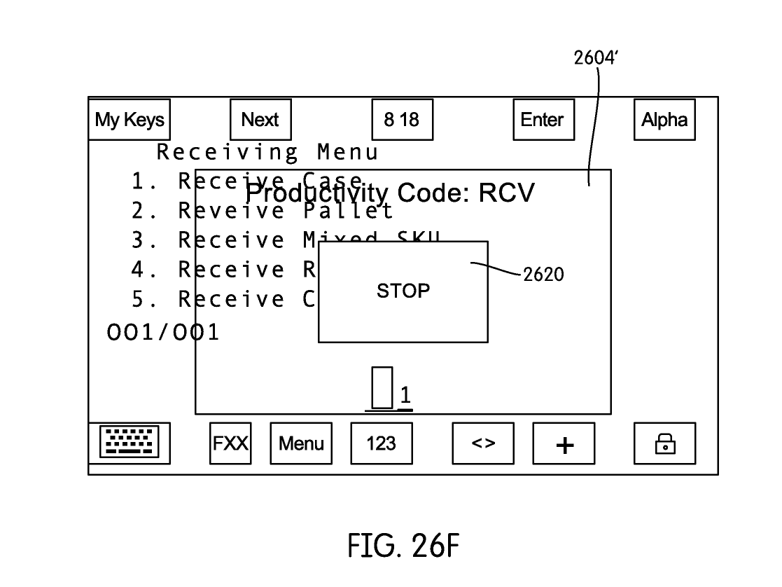

The productivity counter can maintain a number of scans or any other activity of the mobile electronic device 101 and periodically transmit the number of scans or recorded activities of the mobile electronic device 101 to the remote computer 104. In various embodiments, the productivity counter can include adders, multipliers, comparators, timers, and event listeners, or any combination thereof to calculate productivity metrics in conjunction with the productivity count. The productivity counter may be communicatively interfaced with a scanning device connected to the mobile electronic device 101 to receive indications of scans and update the productivity count. The timer of the productivity timer may keep track or measure duration of time between scans. The productivity count may include, for example, units scanned per hour, units scanned per step, total units reported, a total time elapsed, units scanned per distance traveled, total number of steps traversed, and total distance traversed, among others. In various embodiments, the productivity counter can maintain the productivity count per time-interval or per-step interval, assignment identifier, and an operator identifier. The time interval can identify the time at which the scans are recorded. The step interval can identify how many steps measured through a pedometer or any other sensor on the mobile electronic device that the operator of the mobile electronic device takes between each scan. The step interval may also take into account height, physical activity, standing time, and weight of the operator of the mobile electronic device, among others parameters. The assignment identifier may be used to further identify the scans. For example, scans may be divided by assignments or projects at a distribution center. The operator identifier may correspond to the operator or user of the mobile electronic device 101 for the scans. In various embodiments, the productivity counter may initiate maintenance or counting of the productivity count, responsive to an initiation command. In various embodiments, the productivity counter may initiate the session timer, responsive to receiving the initiation command. In various embodiments, the productivity counter may terminate maintenance or counting of or may reset the productivity count, responsive to a termination command or reset command. In various embodiments, the productivity counter may terminate or rest the session timer, responsive to receiving the termination or reset command. The initiate command, termination command, and the reset command may be received via an activation or interaction with the user interface (e.g., FIGS. 26B, 26C, and 26F) displayed on the touchscreen display of the mobile electronic device 101.

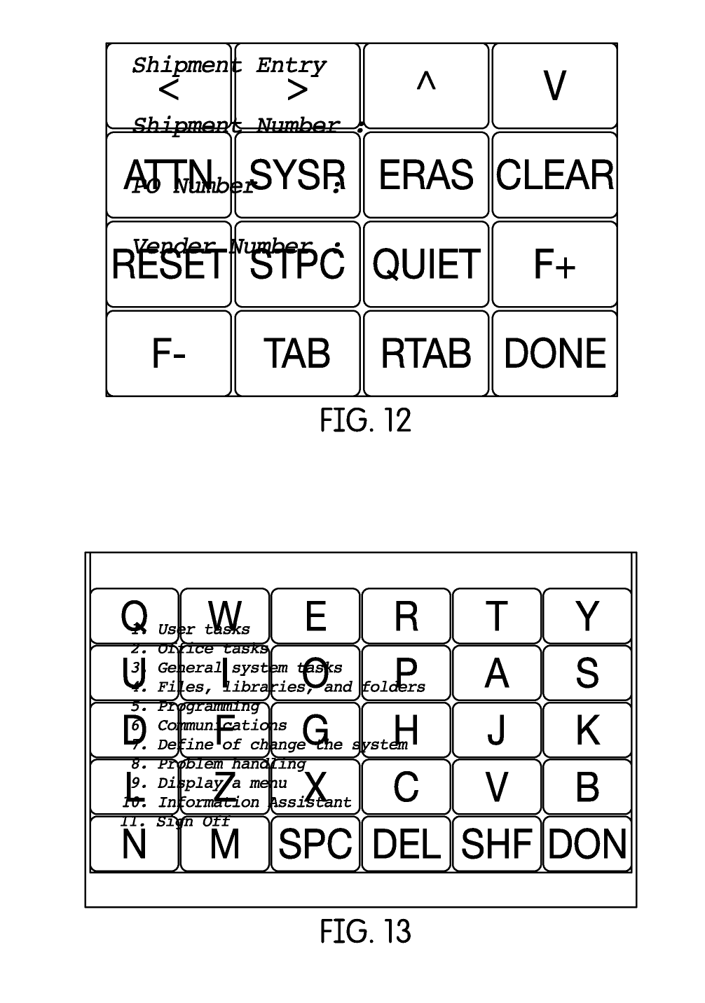

The control button generator may generate a see through touch sensitive buttons for display on the mobile electronic device 101, such as the touchscreen display of the mobile electronic device 101 described herein in conjunction with FIGS. 12-16F and 26A-F. In various embodiments, the control button generator may include one or more event listeners to detect interaction with or activation of the see through touch sensitive buttons on the touchscreen display of the mobile electronic device 101. In various embodiments, the see through touch sensitive buttons or control may include one or more touch-sensitive keys to send code or data to the remote computer 104 responsive to activation. The user interface engine also generate and render any user interface for display on the mobile electronic device 101, as described herein.

The user interface engine may also render the soft-overlay keyboard, see through touch sensitive buttons, transparent control, or otherwise any keyboard interface generated by the control button generator on the display of the mobile electronic device 101. In various embodiments, the user interface engine may render and display content of the terminal emulator application received from the backend system of the remote computer 104. The user interface engine may cause a graphics card of the mobile electronics device 101 to render and display the see through touch sensitive buttons and other user interface content, as described herein in conjunction with FIGS. 12-16F and 26A-F. In various embodiments, the control button generator may include one or more event listeners to detect interaction with or activation of the content displayed on the touchscreen display of the mobile electronic device 101. The user interface engine may render and display content from the productivity counter. The user interface engine may render and display the see through touch sensitive buttons or control generated by the control button generator, while simultaneously continuing to display the content from the terminal emulator application and the productivity counter.

In various embodiments, the control button generator may configure one or more macros for each button of the see-through touch sensitive buttons. Each of the one or more macros may correspond to a set of instructions or functions for the mobile electronic device 101. The set of instructions or functions may be associated with instructions or functions that may otherwise include multiple button presses. Configuring one or more macros may thus improve human-computer interaction between the operator of the mobile electronic device 101 and the mobile electronic device 101 by decreasing the number of key presses that the operator may have to take to trigger the same set of instructions or functions. For example, a login sequence macro may allow an operator of the mobile electronic device 101 to login or authenticate a session by pressing a single see-through touch sensitive button once to trigger the corresponding the login sequence, instead of going through each step of the login process. In another example, a task group assignment macro may allow the operator of the mobile electronic device 101 to press a single see-through touch sensitive button once to be assigned to a task (e.g., scanning) and receive task data. In yet another example, an equipment macro may allow the operator of the mobile electronic device 101 to specify with which equipment to communicatively couple the mobile electronic device 101. The control button generator may configure the one or more macros to correspond to any number of see-through touch sensitive buttons or any sets of instructions or functions. For example, one macro may correspond to 100 hundreds, thereby reducing the number of key presses from 100 to 1.

In various embodiments, the remote computer 104 may include the enterprise application, operations management module, and an installation module. Each of the enterprise application, the management module, and the installation module may execute, operate, or otherwise run on one or more processors of the remote computer 104. Each of the enterprise application, the management module, and the installation module may be implemented in software or hardware, or any combination thereof. The remote computer 104 may include one or more memory storage to store computer-readable instructions and one or more processors to execute the stored computer-readable instructions. The remote computer 104 may also include one or more input and output devices, such as a keyboard, mouse, headphone, transceiver, speaker, microphone, touchscreen display, and remote control, among others.

The enterprise application may maintain an inventory count, categorized by one or more properties specifying units scanned in the inventory. The enterprise application may maintain a counter or adder for updating the inventory count. The enterprise application may also maintain a communications interface for receiving inventory counts from mobile electronic devices 101 communicating with the remote computer 104 via the transceiver. The enterprise application may update the inventory count at predefined intervals.

The operations management module of the remote computer 104 may maintain a productivity count. The operations management module may maintain a counter for updating the productivity count. The operations management module may interface with mobile electronics devices 101 communicating with the remote computer 104 to receive productivity counts. The operations management module may include comparators, adders, and multipliers, among others to calculate productivity metrics for each of the mobile electronics devices 101 or for each operator associated with the mobile electronic devices 101. The productivity count may include, for example, units scanned per hour, units scanned per step, total units reported, total number of steps traversed, total distance traversed, and a total time elapsed. In various embodiments, the productivity counter can maintain the productivity count per time-interval, assignment identifier, and an operator identifier. In various embodiments, the operations management module of the remote computer 104 may receive the productivity count from the mobile electronic device 101 at a predefined time interval. In various embodiments, responsive to receiving the productivity count, the mobile electronic device 101 can set the productivity count maintained on the remote computer 104 to the productivity count received from the mobile electronics device 101.

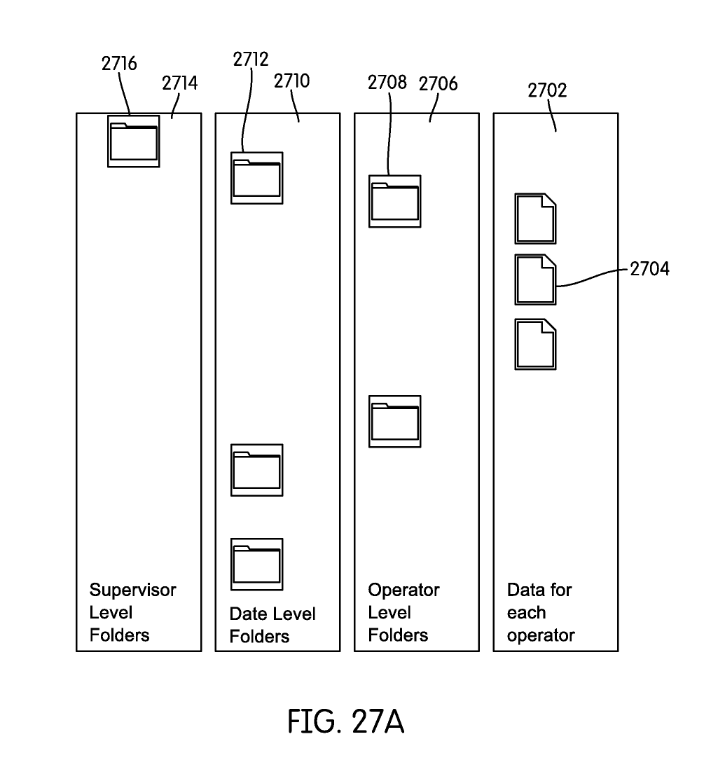

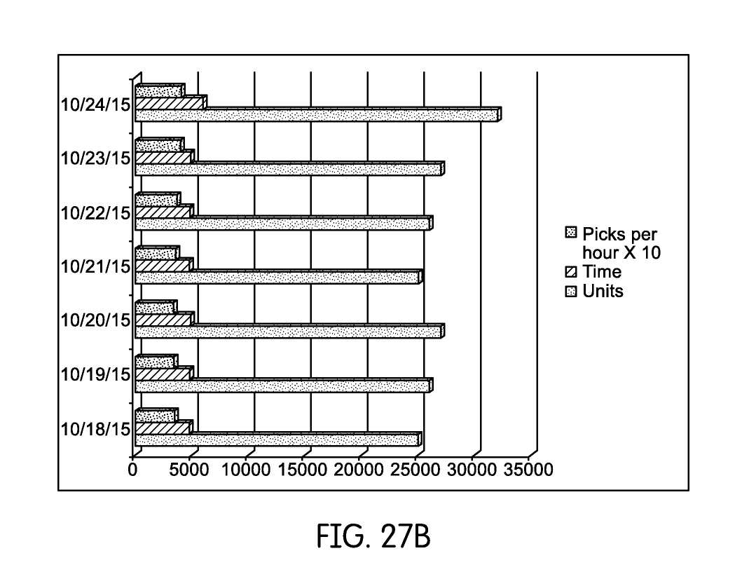

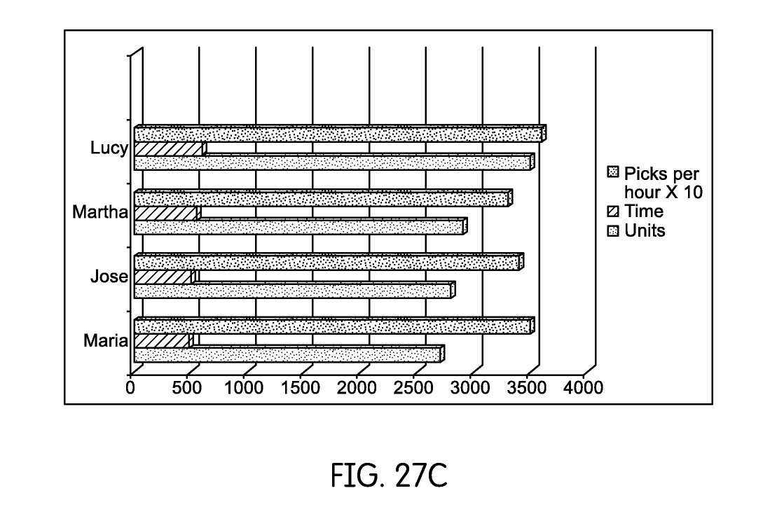

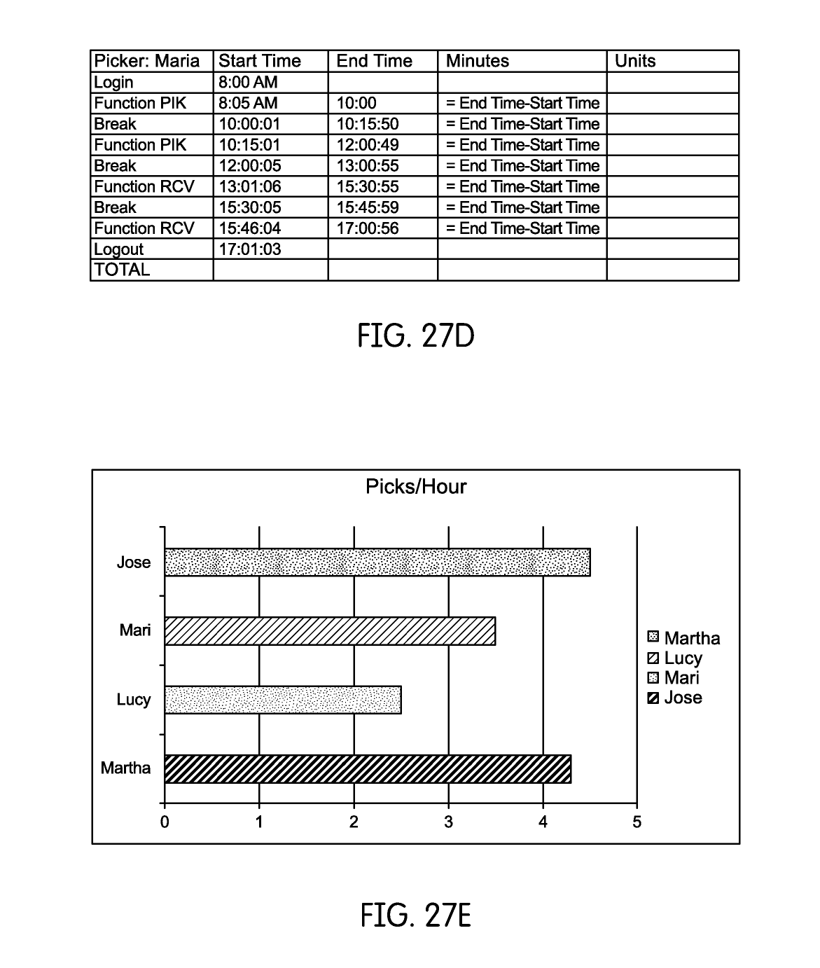

In various embodiments, the operations management module may transmit the productivity count for the mobile electronics device 101 to another computing device (e.g., a tablet such as the iPad, Galaxy Tab, Surface Pro or another mobile device similar to the mobile electronic device 101). In various embodiments, the productivity count and other information (e.g., operator identifier, assignment identifier, and time interval, etc.) may be transmitted, responsive to a request for the productivity count. In various embodiments, receipt of the productivity count may cause the other computing device to calculate productivity metrics based on the productivity count and the other information and display the calculated productivity metrics. Productivity metrics may include scans or picks per house, time interval, and units scanned. The productivity metrics may be displayed in bar or chart form, as depicted in FIGS. 27A-E.

In various embodiments, the operations management module of the remote computer 104 may transmit an alert indicator to the mobile electronic device 101 or the other computing device based on a predefined condition. In various embodiments, the operations management module of the remote computer 104 may calculate an average productivity count across a plurality of mobile electronic devices 101 or across productivity counts associated with a plurality of corresponding operator identifiers. In various embodiments, the operations management module of the remote computer 104 may compare the productivity count for an individual mobile electronic device 101 or an associated operator identifier to the average productivity count or a predefined threshold. If the productivity count for the individual mobile electronic device 101 or the associated operator identifier is below the average productivity count or below the predefined threshold, the operations management module may transmit a negative alert indicator to the respective mobile electronic device 101. The negative alert indicator may indicate that the productivity count associated with the mobile electronic device 101 is below the average productivity count or below the predefined threshold. For example, if the units scanned per steps the operator of a mobile electronic device is below a threshold of 1 unit per 35 steps, the operations management module may generate and transmit a negative alert indicator to the mobile electronic device for display. If the productivity count for the individual mobile electronic device 101 or the associated operator identifier is above or equal to the average productivity count or below the predefined threshold, the operations management module may transmit a positive alert indicator to the respective mobile electronic device 101. The positive alert indicator may indicate that the productivity count associated with the mobile electronic device 101 is above the average productivity count or above the predefined threshold. In various embodiments, the operations management module can transmit the positive alert indicator or the negative alert indicator to the other computing device.

The installation module can transmit the application 102 via the transceiver for installation at the mobile electronic device 101. The application 102 may include the terminal emulator application, the productivity counter, the control button generator and the interface engine with functionalities as described above. In various embodiments, the installation module can transmit the application 102 to the mobile electronics device 101, responsive to a request to download the application 102 transmitted by the mobile electronics device 101. The illustrated embodiments discuss inventory management enterprise system in detail, as demonstrated herein; the scope of illustrative embodiments is not limited thereto.

FIG. 2 shows a mobile electronic device for implementing the terminal emulation system of FIG. 1. A mobile electronic device in accordance with inventive embodiments disclosed herein can include a device with a processor, a memory, a tactile user interface, and a weight of less than 1.12 lbs. A mobile electronic device in accordance with various inventive embodiments may have a weight of less than 1.1 lbs., a weight of less than 1 lb., a weight of less than 0.9 lbs., a weight of less than 0.8 lbs., a weight of less than 0.7 lbs., a weight of less than 0.6 lbs., a weight of less than 0.5 lbs., a weight of less than 0.4 lbs. or a weight range between any of the aforementioned weights. A mobile electronic device in accordance with various inventive embodiments can include an iPod Touch, an iPhone, a mobile phone with a touch screen or a tactile user interface, an Android watch, an Apple watch.

In FIG. 2, exemplary mobile electronic device 201 is illustrated as an iPod Touch. The mobile device in accordance with various inventive embodiments may include other mobile electronic devices, such as mobile phones, running operating system software such as Android or Windows or other mobile operating systems. As illustrated in FIG. 2, in various embodiments mobile device 201 may be removably coupled to a holster 202, which may include a built in battery 203 which may be connected to device 201 by input device such as cable 205. Holster 202 may be configured to hold device 201 when device 201 is disposed in a protective case 204. Holster 202 may include one or more straps 206, which may be adjustable, elastic, or in other suitable forms for removably coupling the device to a user. In some embodiments, device 201 may be positioned in a hand held holster. Device 201 may be communicatively coupled, for example, wirelessly coupled, to a scanner or detection device, such as ring scanner 207. In various embodiments, device 201 may be coupled to a bar code scanner, an imager for scanning 2D and 3D barcodes, near field communication detection device, an RFID scanner, or other detection device. In various embodiments, the scanner or detection device may be integral with the mobile electronic device. In various embodiments, an image or video capture device of the mobile electronic device may be implemented for object detection, scanning etc.

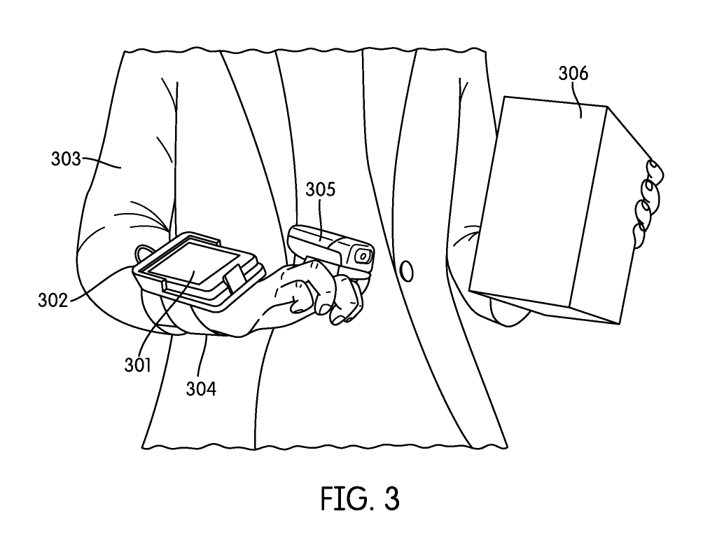

FIG. 3 illustrates another mobile electronic device embodiment for implementing the terminal emulation system of FIG. 1. As depicted in FIG. 3, mobile electronic device 301 may be coupled to harness 302 configured for attachment to the arm of a user 303, by one or more straps 304 and wireless coupled to scanner 305 configured for scanning data from product 306 and transmitting information to device 301 based on the scanning for processing through the terminal emulation portal hosted on device 301 to communicate with, for example, an inventory control system, warehouse management systems, or ERP systems. Scanner 305 may include a Barcode ring scanner like Honeywell 8650 scanner with battery.

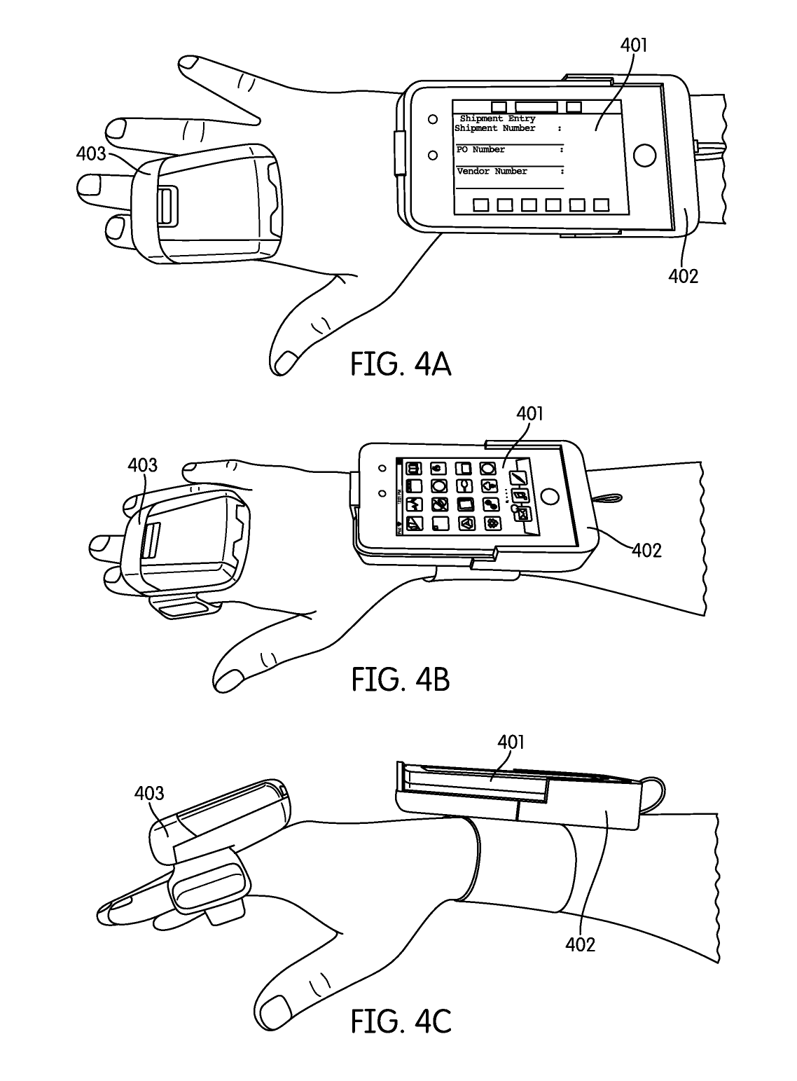

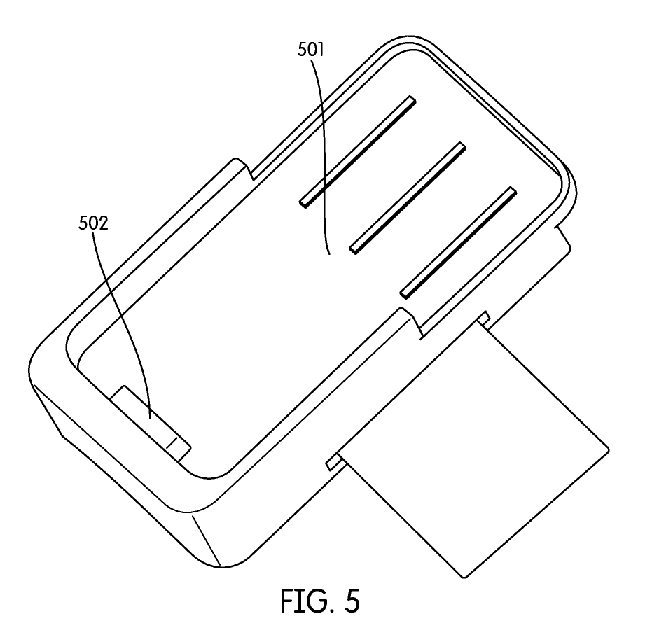

FIG. 4 illustrates a wearable sleeve for holding a mobile electronic device implemented for terminal emulation on an operators arm in accordance with illustrative embodiments. As demonstrated in the illustrated embodiment, sleeve or harness 402 may be configured for removably coupling with mobile electronic device, iPod touch 401. Device 401 may be wired or wireless connected to scanner 403, which may include, but is not limited to a blue-tooth scanner, for scanning the barcodes in the products, cases, locations as part of their operations for faster inputs.

Referring again to FIG. 1 in conjunction with FIGS. 2-4, in various embodiments, responsive to each scan or detection by a scanner or detection device, the productivity counter of the application 102 may update the productivity count. In various embodiments, the productivity counter may transmit via the transceiver of the mobile electronic device 101 the productivity count to the remote computer 104. In various embodiments, the productivity counter may transmit the productivity count at a predefined time interval or in near real-time. In various embodiments, the productivity counter may transit the productivity count and an operator identifier associated with the operator of the mobile electronic device 101. In various embodiments, the transceiver of the mobile electronic device 101 may be in bi-directional wireless communication with another computing device (not shown in FIG. 1) (e.g., a tablet such as the iPad, Galaxy Tab, Surface Pro or another computing device similar to the mobile electronic device 101). In various embodiments, the productivity counter may transmit the productivity count via the transceiver to the other computing device. In various embodiments, the productivity counter may transmit the productivity count via the transceiver to the other computing device at a predefined time interval or in near real-time. In various embodiments, the productivity counter may transmit the productivity count along with other information to the other computing device, responsive to receiving a request from the computing device or the remote computer 104.

FIG. 5 shows a case for increasing impact resistance and durability of a mobile electronic device implemented for terminal emulation in accordance with illustrative embodiments. Case 501 may include an integral battery compactly configured to connect directly to a mobile device via connection 502.

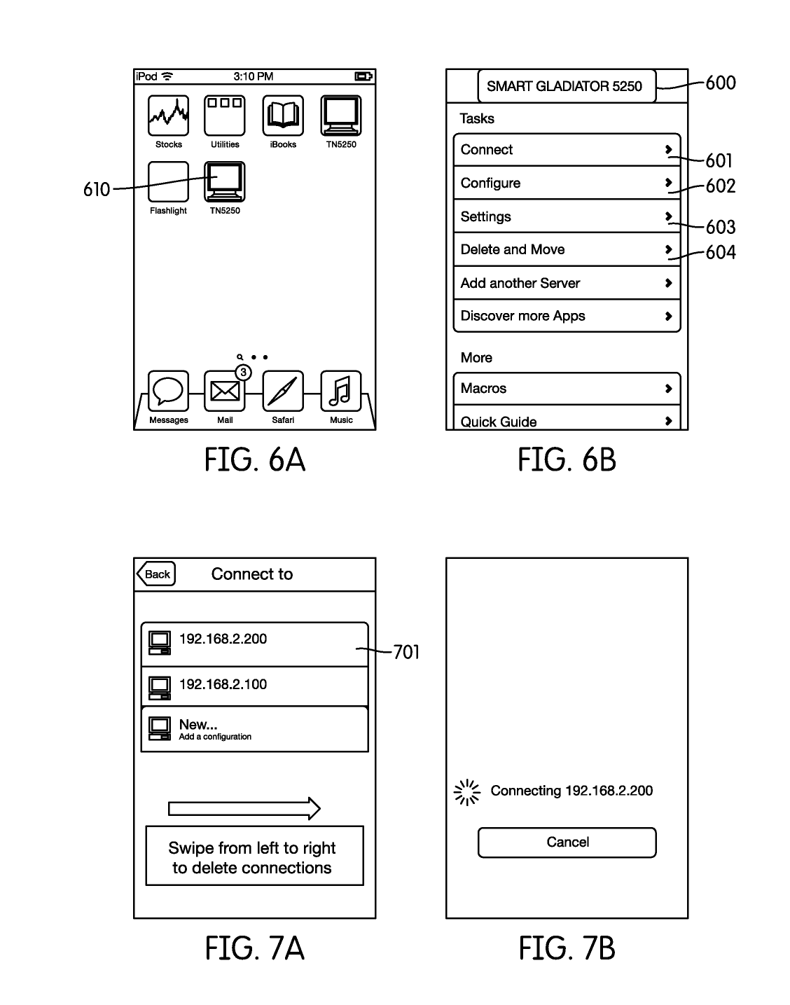

FIG. 6A illustrates a display of a device, such as an iPod touch, having a terminal emulation application, icon 610, in accordance with exemplary inventive embodiments disclosed herein installed therein. Selecting application 610 via the touch screen display initiates the application as further demonstrated in FIG. 6B.

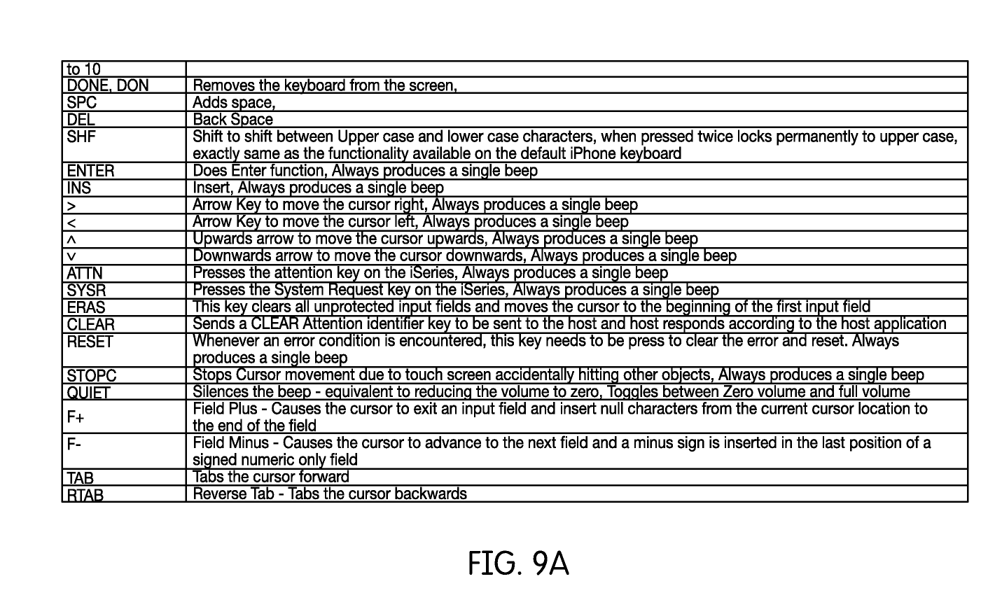

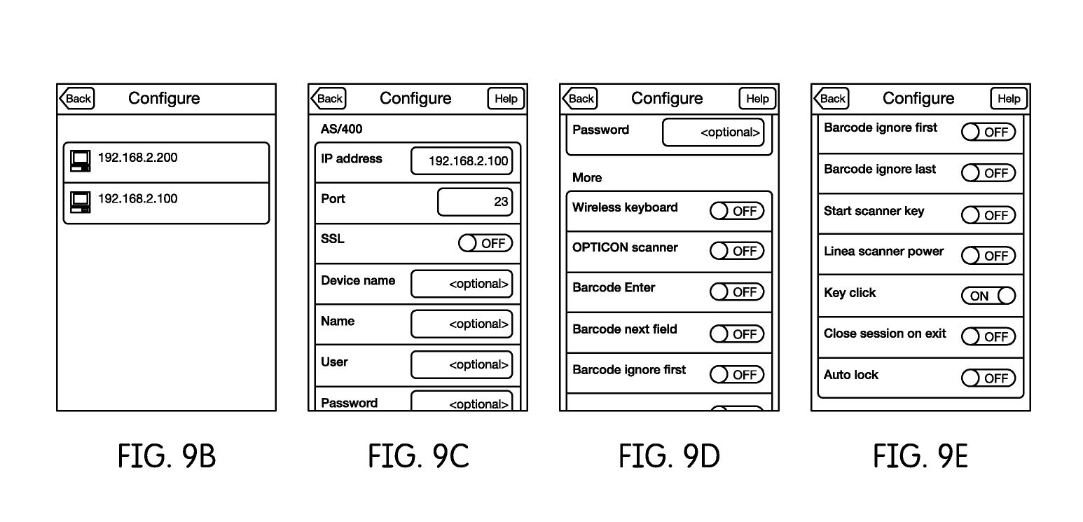

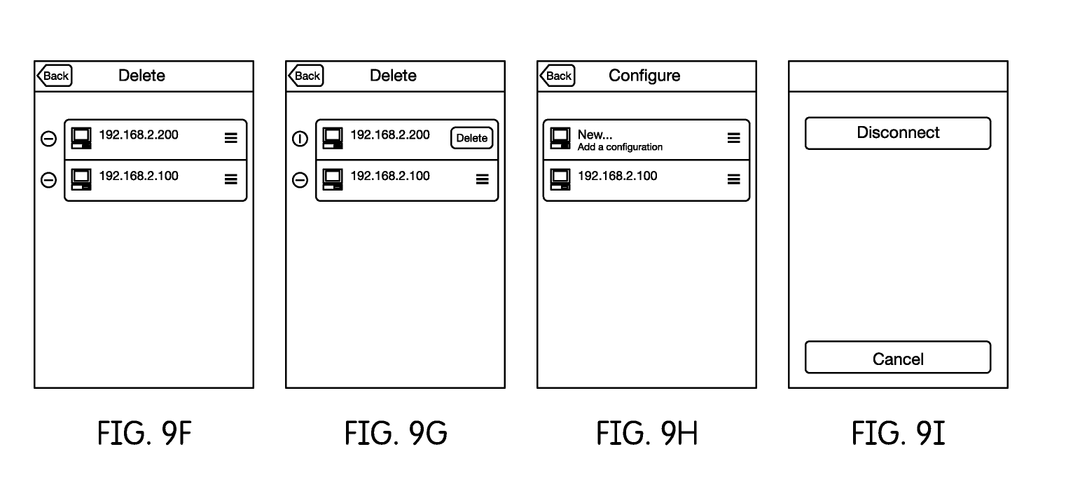

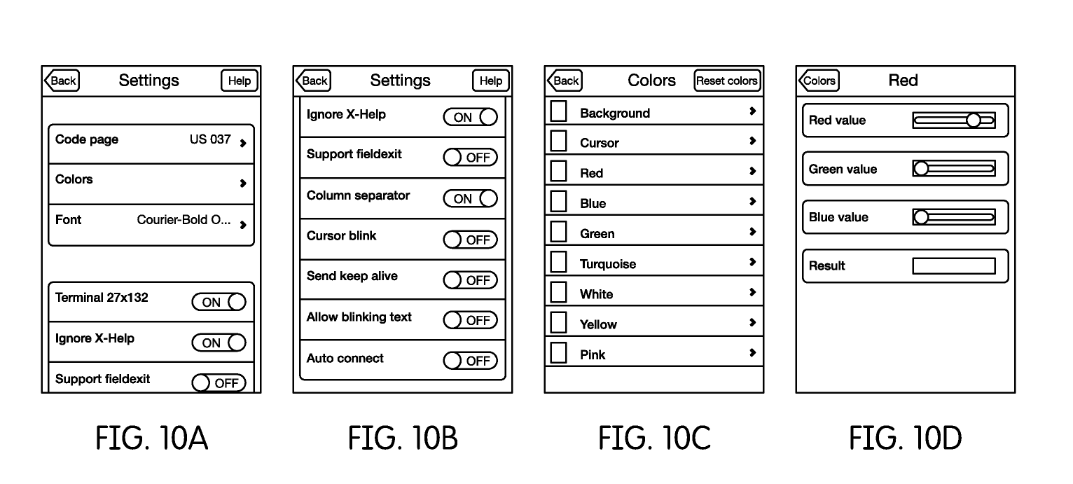

FIG. 6B provides a screen shot of an initiation screen displayed on a mobile device at the start of a terminal emulation session in accordance with illustrative embodiments. Screen 600 may be displayed on a mobile electronic device such as iPod touch device 101 when the terminal emulation application is initiated on the device. As demonstrated in FIG. 6B, initiation of the application may enable a variety of functions such as connection function 601, configure function 602, settings function, 603, delete function 604 or other functions implemented in accordance with various embodiments. Connect function 601 enables device 101 to connect with a remote computer device, such as device 104, thereby creating a new session. Touching the connection function 601 on the screen will bring up additional options and facilitate initiation of additional processes discussed in greater detail in connection with FIGS. 7A and 7B. Configure function 602 causes device 101 (for example via a processor running the terminal emulation application) to display a screen that allows a user to configure the connection information related to remote computer device 104 to which the device connects, as will be discussed in greater detail in connection with FIGS. 9A-9E. Settings function 603 causes device 101 to display a screen that allows a user to configure settings, which may be unrelated to connectivity such as font, code page, screen size, etc., as will be discussed in greater detail in connection with FIGS. 10A-10D. Delete and move function 604 causes device 101 to display a screen that permits the user to delete a configured remote computer. In particular embodiments, screen 600 may include a collaborate tab in the task menu. The collaborate option opens an interface with a communication interface such as Facetime and permits a user to configure their contact in that interface.

FIGS. 7A and 7B show screenshots of the connection screens displayed on a mobile device at the start of a terminal emulation session in accordance with illustrative embodiments. Once a user initiates a connection procedure via connection function 601, the terminal emulation application may cause device 101 to display a list 701 of remote computer devices (which may be identified by their IP address or other naming convention), such as device 104, that the system running on device 101 has been configured to connect to. A user can select a computer from list 101. A user also has the option to select option 702 “New” to add new server to the list. When a user selects option 702 “New” the application takes the user to the “Configure” screen described in FIGS. 9A-9I. In particular embodiments, a user has the option 703 that permits the user to perform a swipe and delete function of the configured connections. A user may perform the action of swiping across the screen from left to right to perform the delete function. This action will take the user to screen 9 shown in FIGS. 9F-9I.

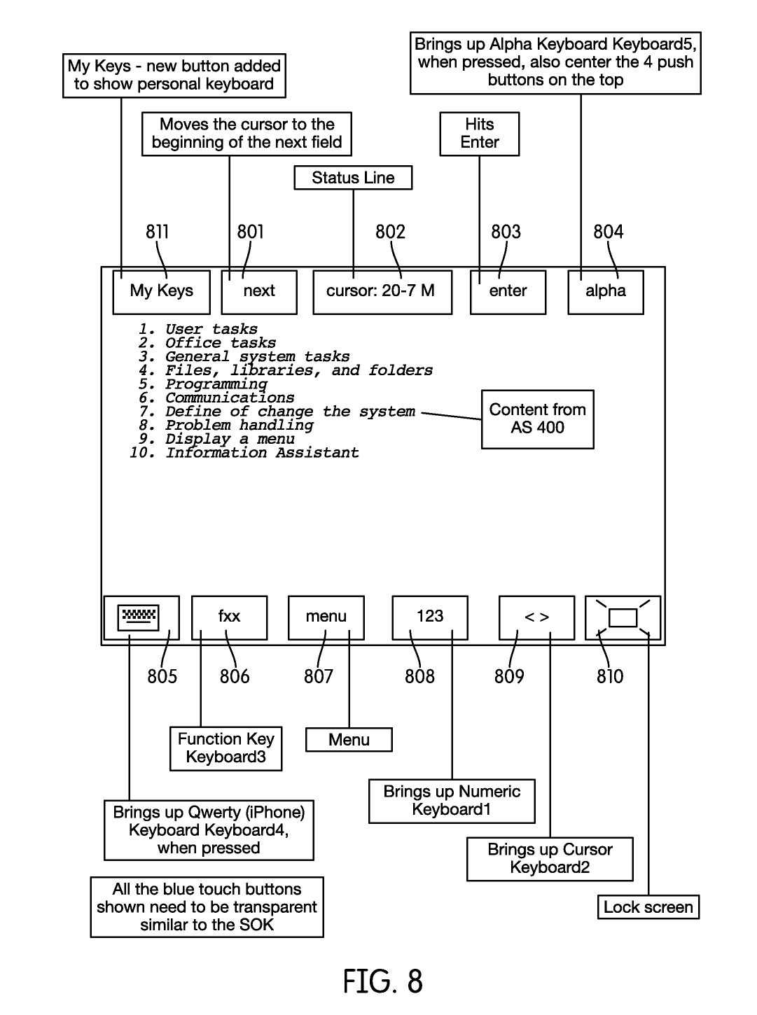

In response to a user selecting a computer from list 101, the application causes device 101 to attempt to wirelessly establish a telnet or ssl or ssh or http or https connection with the selected computer, which connection activity may be indicated by the display screen illustrated in FIG. 7B. If the application is unable to connect device 101 with the selected computer, an error message may be displayed on device 101. If the application, establishes a connection with the selected remote computer, the terminal emulation such as depicted and discussed in connection with FIG. 8 may be displayed. When the connection with the selected computer is established and the screen of remote computer 104 is displayed, pressing the home bottom device 101, such as the iPod touch home button to go to iPod home screen, should persist the session if a “Close Session on Exit” configuration setting is in OFF mode. A user may touch the application 610 icon to get back and continue in the remote computer session from where he left off If the “Close Session on Exit,” shown in FIG. 9E, configuration setting is in ON mode, the application 102 disconnects the remote computer session and exits. Accordingly, when the user re-enters the application 102, after exiting, the user is taken to the session initiation screen.

In various embodiments, establishing a telnet or ssl (secure sockets layer) or ssh (secure shell) or http (hypertext transfer protocol) or https (hypertext transfer protocol secure) connection may cause the display screen of device 101 to transition from portrait to landscape. The screen orientation may be locked and may stay in landscape mode during the connection in accordance with various embodiments. The screen orientation may return to portrait mode once the connection with the selected remote computer is terminated or disconnected in accordance with various embodiments.

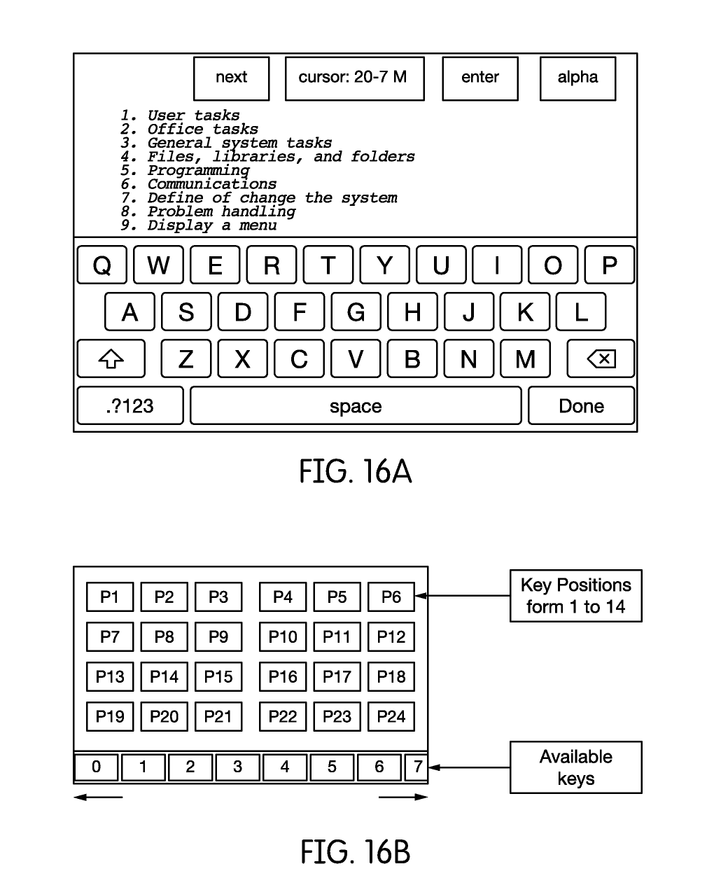

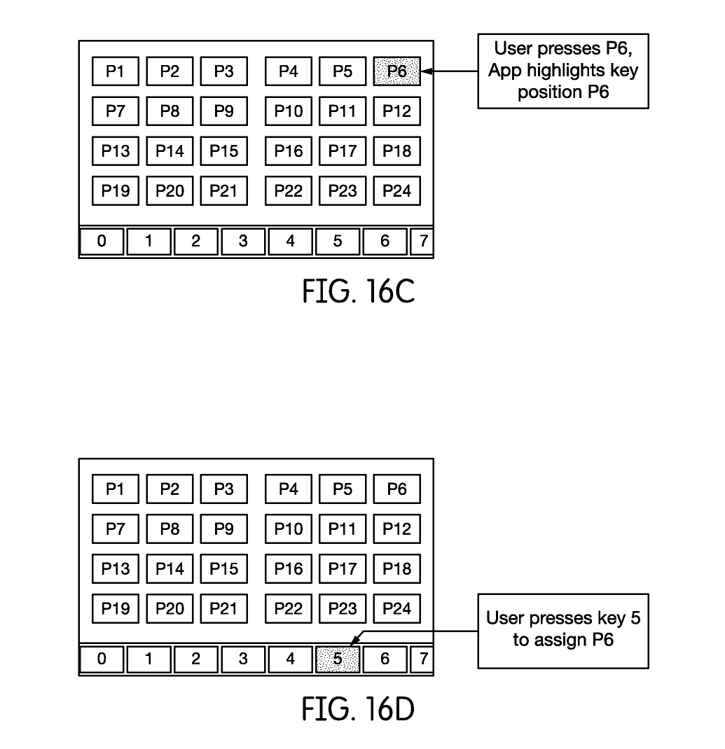

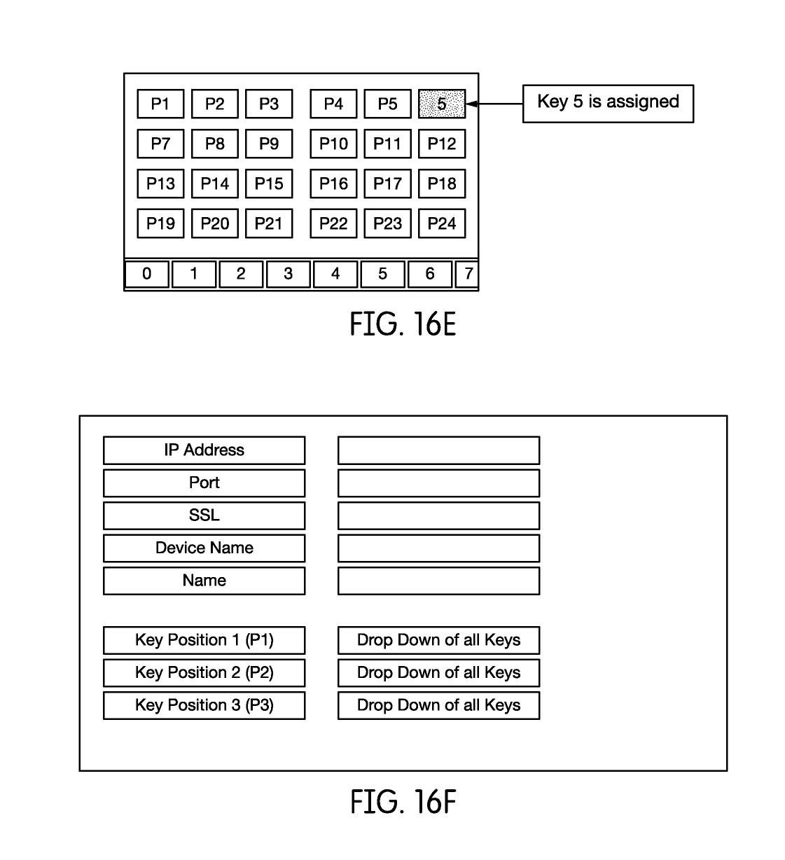

FIG. 8 illustrates a screen shot of the emulated terminal as displayed on the mobile device upon connection to a remote computer terminal in accordance with illustrative embodiments. As shown in FIG. 8, the content from the remote computer 104 (e.g. AS 400 in the illustrated embodiment) is displayed and in the example embodiment can include 11 soft keys displayed on the screen 801-810 configured to cause specific actions or initiate displays of various see through touch sensitive buttons demonstrated and discussed in connection with FIGS. 12-15. Key 801 facilitates moving the cursor displayed on the content display from the remote computer. Key 802 provides a status line that will change based on the status of the terminal and the information being displayed. The status line can indicate a variety of messages including messages that indicate whether a session is active or online, where the cursor is positioned, or whether the remote computer is busy or processing, etc. Key 803 permits the user to enter information or initiate a selection or command. Key 804 causes a soft-overlay alpha keyboard to display on the screen of device 101. Key 805 causes a QWERTY keyboard to be displayed on the display screen of device 101. Key 806 causes a soft-overlay function keyboard to display on the screen of device 101. Key 807 brings up a menu. Key 808 causes a soft-overlay numerical keyboard to display on the screen of device 101. Key 809 causes a soft-overlay cursor keyboard to display on the screen of device 101. Key 810 causes the display screen to lock. Key 811 causes display of a personal keyboard described in further detail in connection with FIGS. 16B-16F.

FIGS. 9A-9I illustrate screenshots of various configuration parameters selectable via a mobile electronic device in connection with connecting to a remote computer terminal in accordance with illustrative embodiments. Screens 9A-9F are invoked through a user selecting the configure option 602 on screen 600. In response to such a selection, a user may be presented with the display screen of FIG. 9A, which permits the user to configure the remote computer to which he or she desires to connect. In particular embodiments, a user can configure 6 different remote computers in the application 102. FIGS. 9B-9F provide screenshots of the configuration screens. The configuration screen shown in FIG. 9B provides user with a list of remote computer devices, identified in the illustrated embodiment by their IP address. In response to the user selecting a computer for configuration from the list of FIG. 9B, the user will be permitted to enter or select various options shown in FIGS. 9C-9E regarding configuring the connection to the selected computer. FIG. 9C represents a top screen shot of the selectable configurations. FIG. 9D represents an intermediate or middle portion of the selectable configurations, which options are viewable in response to a user scrolling down the list. FIG. 9E represents a bottom screen shot of the selectable configurations, which options are viewable in response to a user scrolling to the bottom of the list. For example, the key click selection enables the application to cause production of a click sound for every key pressed in all the keyboards. As demonstrated in FIG. 9F-9H, in addition to changing or modifying the connection configuration of listed remote computers, a user may be able to delete or add a new computer or server to the list for configuration and connection thereto. As shown in FIG. 9I, once the user has configured the parameters of the electronic device the user can disconnect to exit the session.

FIGS. 10A-10D show screenshots of various settings selectable via a mobile electronic device in connection with connecting to a remote computer terminal in accordance with illustrative embodiments. Screens 10A-10E are invoked when a user selects the configure option 603 on screen 600. FIG. 10A illustrates the top of the setting options and FIG. 10B illustrates the bottom of the settings options. FIGS. 10C and 10D illustrate various layers of the settings they may be entered in response to selecting an option from the menu such as color.

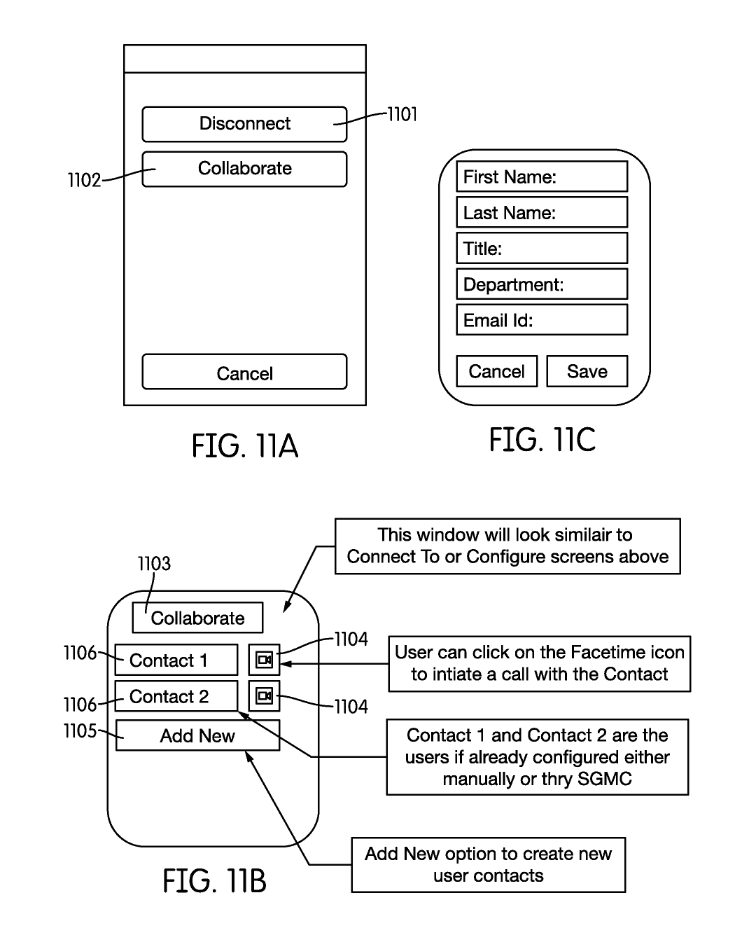

FIG. 11A illustrates a screen shot of a mobile device operable to disconnect from a remote computer terminal, via disconnection option 1101, or collaborate with other users, via collaborate option 1102, in accordance with illustrative embodiments. FIG. 11B illustrates the collaboration screen displayed in response to selection the collaboration option 1102. As shown in FIG. 11B, the collaboration option 1102 allows a user to be able to manually add the contacts that the device can initiate calls, such as Facetime calls, when the user touches the collaborate option 1103. The collaboration screen shown in FIG. 11B also list the contacts 1106 already configured in the application 102 and can include a button to add new contacts to the application 102, in accordance with particular embodiments. The contacts 1106 already configured in the application 102 will be displayed in a list. In response to selection of a user from the list, the application causes the following information, shown in FIG. 11C, to be displayed: First Name Last Name, Title, in accordance with particular embodiments. For example, if Joe Smith is a user already configured in the system and his title can be configured as Shipping Supervisor, the list will display Joe Smith, Shipping Supervisor.

Contacts in the application may be deleted by swiping the screen sideways, similar to delete action on the connection screen, in accordance with example embodiments. When users do the swipe action, a delete icon may appear next to all the users in the list. A user selects the delete icon to delete the contact from the application. A user can initiate a collaborative call, such as Facetime call, with one of the contacts 1106 in the list by selecting the call icon 1104, such as a Facetime icon, on the right side of the contact. When a user presses call icon 1104, the application 102 initiates a Facetime call directly, in accordance with particular embodiments. The application 102 may be edited by selecting the contact from the collaborate screen. When a user selects a contact, the screen that is displayed may be the same as the Add New Contacts screen with the distinction being that the fields are already populated with the existing values. A user clicks on “Add New” option 1105 at the bottom to create new contacts in the application 102. When the Add New option 1105 is selected, the display shown in FIG. 11C is displayed.

A terminal emulation and connection application, in accordance with inventive embodiments disclosed herein running on a mobile device such as the iPod Touch enables a user to interact the mobile device with enterprise systems running on a remote computer such as the IBM Series I/AS 400 computer using the touch screen interface of the mobile electronic device. Inventive embodiments disclosed herein provide a see through touch sensitive buttons superimposed on the terminal emulation display displayed via the touch screen display of the mobile device. The see through touch sensitive buttons provides a virtual keyboard that creates an illusion as if a glass keyboard is placed right above the emulated terminal

The see through touch sensitive buttons shown to the user will be bigger and user friendly in comparison to the standard device keyboard, such as the device QWERTY keyboard. The superimposition of the see through touch sensitive buttons (STTSB) over the content in the screen provides users with bigger keys to interact with while simultaneously continuing to display the information already on the screen. Exemplary embodiments of various STTSBs are described below in connection with FIGS. 12-16F.

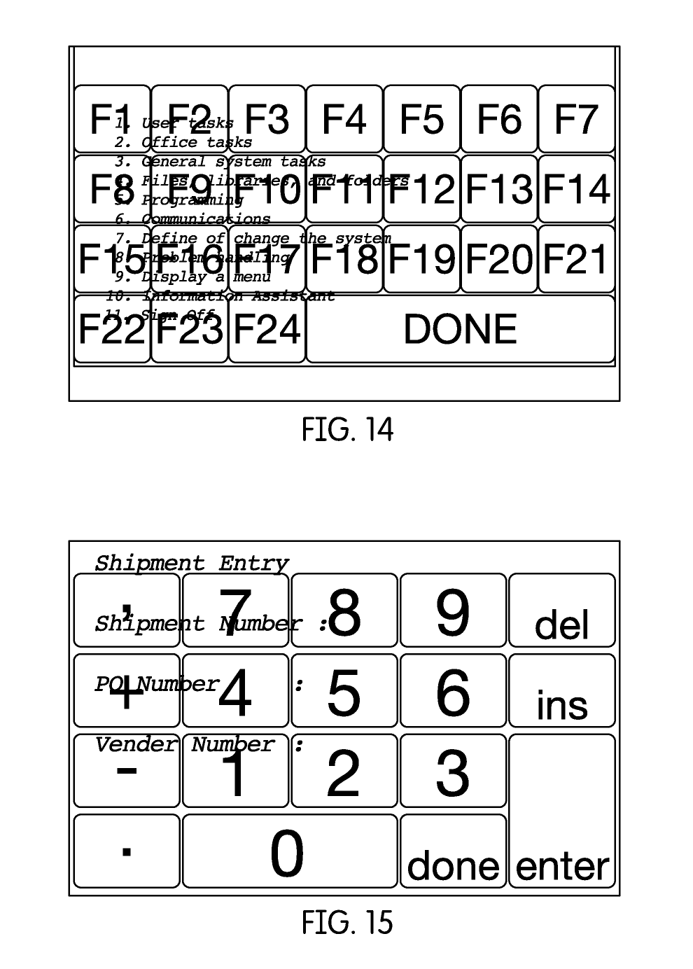

FIG. 12 illustrates a soft-overlay cursor keyboard displayable on a mobile device in connection with connecting the mobile device to a remote computer terminal in accordance with illustrative embodiments. FIG. 13 illustrates a soft-overlay alpha keyboard displayable on a mobile device in connection with connecting the mobile device to a remote computer terminal in accordance with illustrative embodiments. FIG. 14 illustrates a soft-overlay function keyboard displayable on a mobile device in connection with connecting the mobile device to a remote computer terminal in accordance with illustrative embodiments. FIG. 15 illustrates a soft-overlay numeric keyboard displayable on a mobile device in connection with connecting the mobile device to a remote computer terminal in accordance with illustrative embodiments. In accordance with particular embodiments, touching the field exit key sends the field exit code to the remote computer 104 and minimizes the STTSB to go back to the content of the computer 104.

FIG. 16A illustrates a QWERTY keyboard of a mobile device being displayed during a terminal emulation session on the mobile device to a remote computer terminal in accordance with illustrative embodiments.

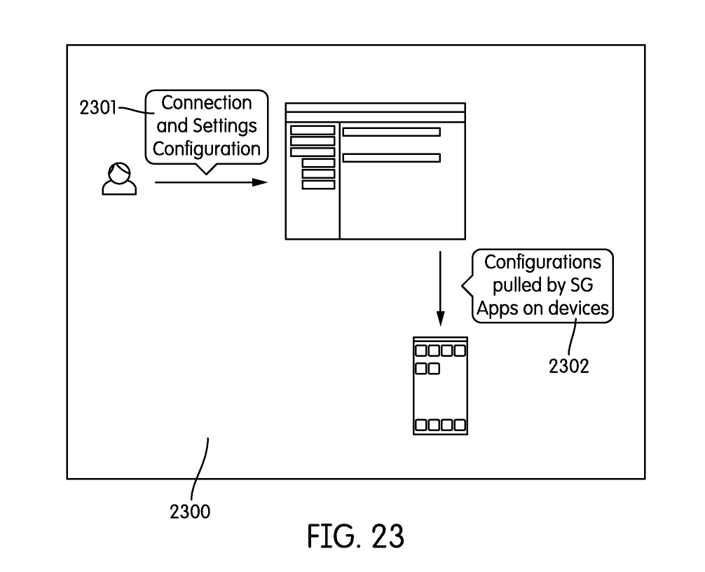

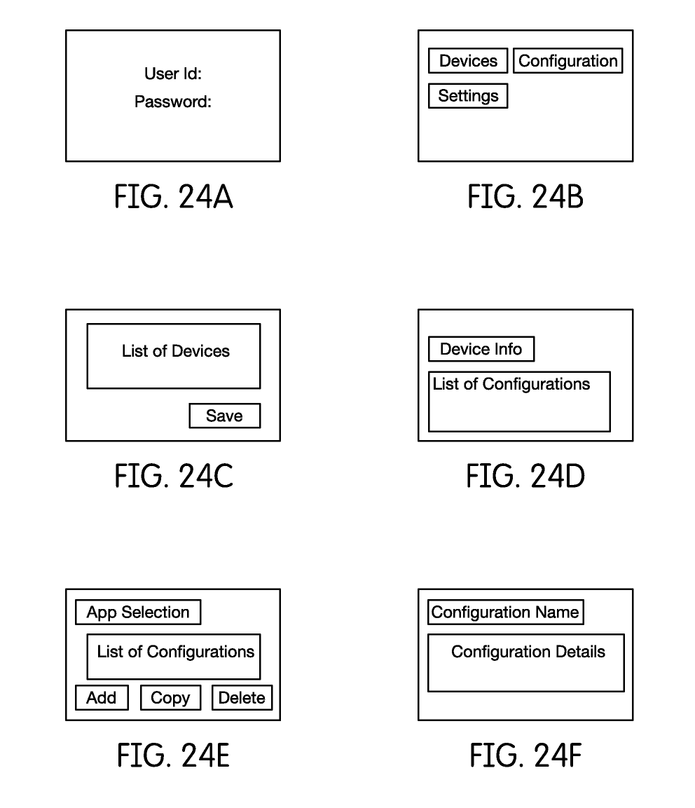

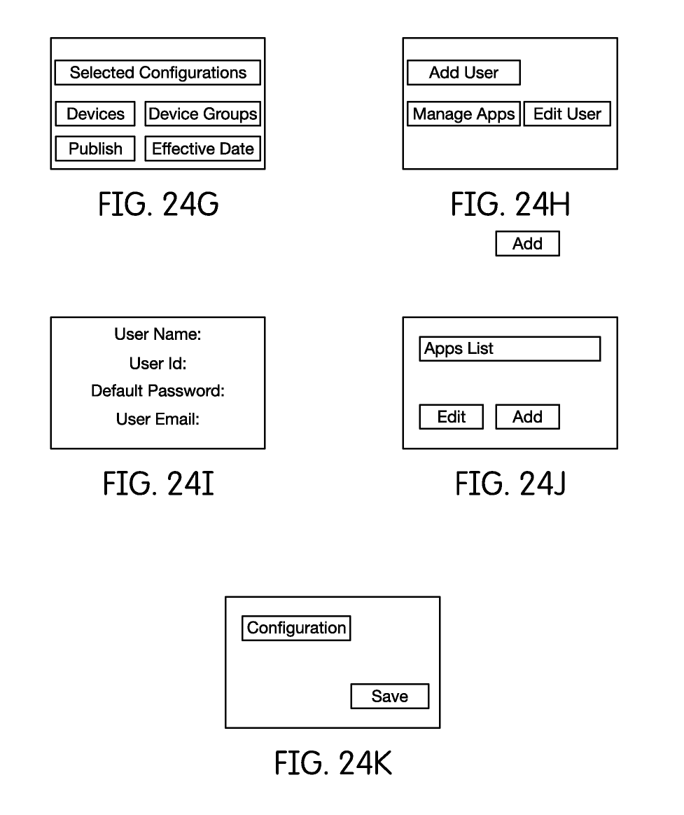

FIG. 16B illustrates a personal keyboard that is displayed when users presses the “My Keys” option 811 from emulated terminal displayed on the mobile device upon connection to a remote computer terminal as shown in FIG. 8. The user has the option of assigning specific keys to key positions on the personal keyboard. The personal keyboard may be of fixed size, with 24 configurable key positions in a 6×4 layout, in accordance with particular embodiments. The user can personalize and assign keys to all 24 key positions or to any of the positions user desires. The personal keyboard can also be configured using a management console, discussed in connection with FIGS. 23-24, and pushed to devices. FIG. 16B shows the display shown to the user when Personal Keyboard option is selected from the emulated terminal. The application 102 may automatically switch to landscape mode when the personal keyboard option is selected and shown. Each key position on the personal keyboard may have a fixed position number assigned to it as shown in FIG. 16B. Key Positions numbers like P1, P2, P3 etc. are also displayed on the screen. These key positions will also be used to assign keys in the management console, discussed in connection with FIGS. 23-24. The bottom row on the screen will display all the available keys that can be assigned to key positions. The bottom row is scrollable from left to right. User can scroll the available keys by making sliding action on the bottom row from left to right and vice versa.

Example available keys that can be assigned to key positions are in table 16.1 below.

TABLE 16.1

| | | |
|---|---|---|
| Numeric Keys | 0, 1, 2, 3, 4, 5, 6, 7, 8, 9 | |
| Alpha Keys Upper | A to Z | |
| case | | |
| Alpha Keys Lower | a to z | |
| Case | | |
| Function Keys | F1, F2, F3 all the way to | |
| | F24 | |
| Delete Key | DEL | Performs delete of text and chars |
| Field Exit | FIELD EXIT | Performs Field Exit |
| Space Key | SPC | Adds a blank Space |
| Enter | ENTER | Hits Enter |
| Insert | INS | Inserts a character |
| Alpha | ALPHA | Brings up the alpha keyboard |
| 123 | 123 | Bring up the numeric keyboard |
| . | . | . to indicate decimals can be added |
| + | + | Plus sign to make adjustments |
| − | − | Minus sign to make adjustments |
| < | < | Left arrow key to move cursor to the left |
| > | > | Right arrow key to move cursor to the right |
| [symbol] | [symbol] | Up arrow key to make the cursor go up |
| | | (inverted V) |
| V | V | Down arrow key to make the cursor go down |
| | | (V) |
| Page Up | PGU | Page Up |
| Page Down | PGD | Page Down |

As shown in FIG. 16C, to assign a key to a key position, user has to press the key position like, P6, and then press the key to assign, as shown in FIG. 16D. When user presses a key position to assign the key, the application will highlight the key position as shown in FIG. 16E. In accordance with particular embodiments, once a key is assigned to a position, the key position is highlighted in a different color to show user that position is already assigned. To un-assign a key from a key position, user has to double-tap the key. In above example, when user double taps the position with key 5, app will un-assign the key 5 and display P6 on the screen. When user brings up the personal keyboard from the “My Keys” button on the emulated screen, only the key positions with assigned keys will be show to the user.

The management console, discussed in connection with FIGS. 23-24, may be configured to create a personal key board via the user interface shown in FIG. 16F and publish it to devices so that all users of certain type have a standard “personal” keyboard.

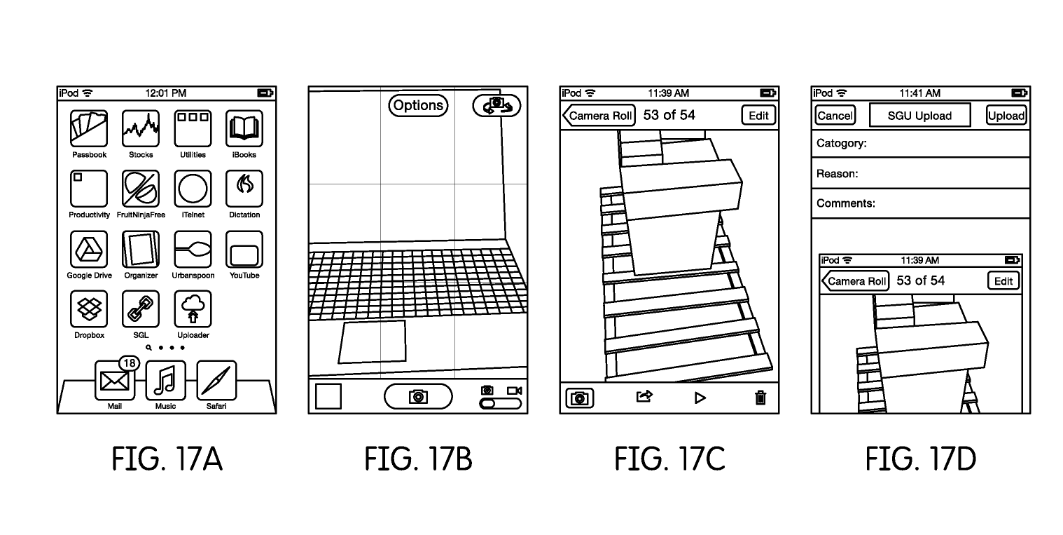

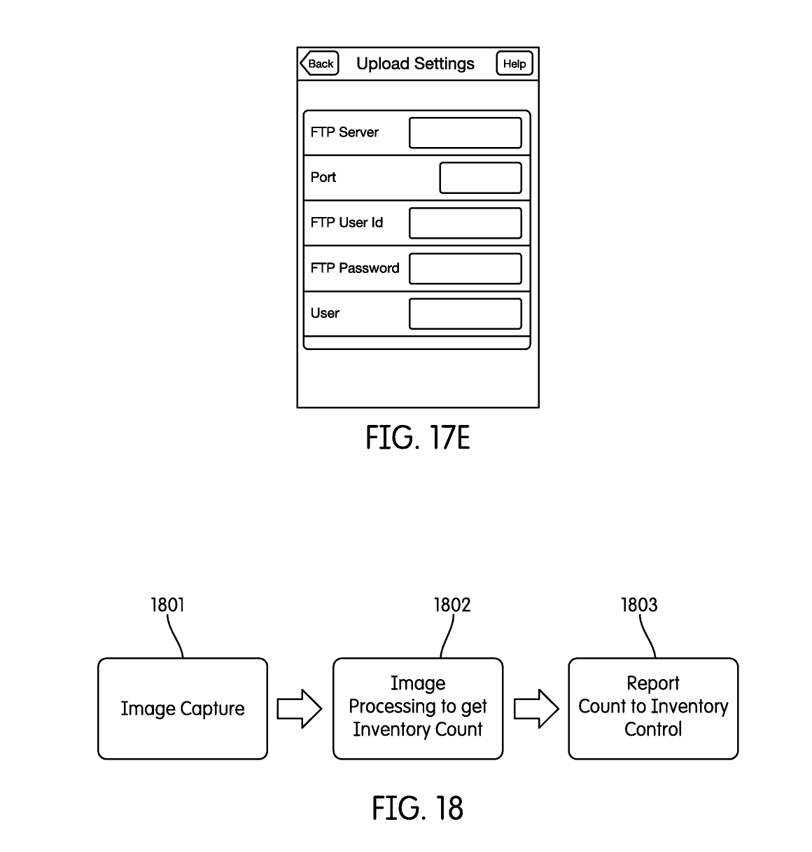

FIGS. 17A-17E depict screenshots of an uploader system transitioning through various processes in accordance with illustrative embodiments. An uploader system is an application in accordance with various inventive embodiments that runs on a mobile device such as an iPod Touch. SGU provides a user interface on the iPod touch device to take pictures and videos and upload them to a portal, such as Google docs or SharePoint, Servers, Computers and other system using variety of protocols like FTP, FTPS, SFTP etc., where users can review them at a later point of time as well as share those pictures with colleagues and business partners. For example, in various embodiments, when a new type, brand, or model of an item is received in a warehouse, the new item may be automatically processed for imaging and the image may be uploaded to an item image database. All the pictures of items stored in the database may be accessible upon request via a mobile electronic device in accordance with exemplary embodiments disclosed herein so that the picture of an item is displayed, for example, during a picking event for verification that the user is picking the correct item. In various embodiments, the uploader system may be running on a mobile electronic device as described herein. In various embodiments the uploader system may be running on a device such as Google glass, wherein the Google glass device is implemented as an input device to obtain images of items of interest, such as inventory items. In various embodiments, the input device may include a mobile electronic device with a user interface configured to receive input via voice commands received from the user.

FIG. 17A is a screen shot showing the uploader icon 1701 for launching the uploader application. FIG. 17B provides a screen shot of the camera application which automatically opens in response to opening the uploader application. From this stage a user can capture an image or video using the native picture and video capture icons of the device. As demonstrated in FIG. 17C, the user may review captured images or videos through device controls such as the camera roll control. Once an image or video is captured the image or video may be selected and uploaded to an FTP site as shown in FIG. 17D. The photo/video is uploaded to the FTP site along with a text file including details such as, the user name of the user creating the image or video, the category of the image, the reason for obtaining the image, additional comments, and a date and time stamp. In various embodiments, the user name may be configured for automatic population upon each use of the device. In various embodiments, the application may be configured to automatically delete the image or video file from the mobile device upon confirmation of successful receipt of the image or video at the FTP site. FIG. 17E provides a screen shot of a settings entry page that may be used to configure the setting of the FTP site.

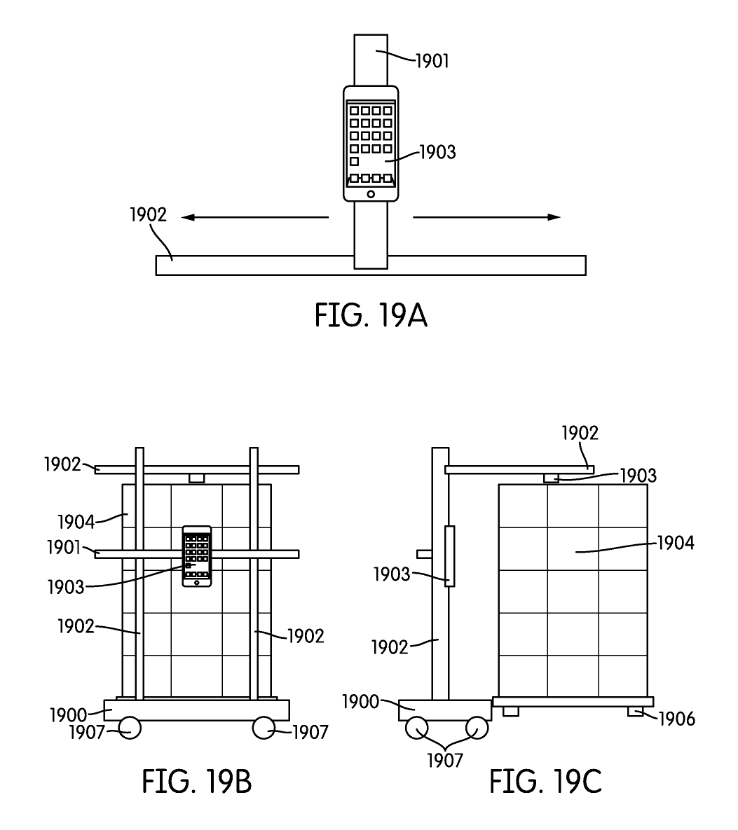

FIG. 18 provides a flow diagram for inventory count by image system in accordance with illustrative embodiments. Inventive embodiments described herein perform inventory count of inventory in a location or a pallet or a truck or any other place that can hold inventory, based on one or more picture of the location with the inventory. The First step is the image capture step 1801. The image of the location or pallet to be counted is captured using device with a camera. Image capture can be performed by an operator with a camera device or automated with a mechanism to capture images of locations, like a camera device that's mounted on a traversing belt or a wheel-pod mechanism as demonstrated in FIGS. 19A-19C. In various embodiments, a panoramic image may be captured as the camera device of a mobile electronic device traverses a side or top of a pallet. The second step 1802 can include processing the image. The image captured is processed using proprietary algorithms to determine the total number of products in the image. The image captured in step 801 is sent to a server/application that has the logic to process the image and get the count. The server application uses heuristic algorithms to determine the inventory count from the picture. Image processing toolkits from programs such as MathWorks may be used to develop heuristics algorithms. The algorithms work by identifying the edges of the boxes and cartons of the inventory, deriving the shapes of the boxes using the edges and then counting the number of shapes in any given image. A standard reference profile of a single unit of inventory may be used to determine the number of units in a given image. Multiple images of the inventory at various views/angles may be required to accurately calculate the count of inventory. This process of inventory count is much faster and accurate than manual counting as user just has to take a picture of a location and the actual counting will happen in the software algorithm. Once the server application has determined the inventory count from the picture, step 803 will be engaged to report the count to the inventory control systems. Some inventory control systems provide APIs or Web Services that can be invoked from the image processing system to send the count information. Count information can also be written in a specific file format for other systems to consume.

FIGS. 19A-19C provides a schematic diagram of an inventory count by image system in accordance with illustrative embodiments. FIG. 19A provides a top view of the inventory count system 1900. As demonstrated in FIG. 19A, the system may be implemented via a movable frame or robotic platform 1901 having a framed structure 1902 configured to position one include one or more image capture devices 1903, such as a mobile electronic device as described herein including, but not limited to, an iPod touch, at various orientations with respect to inventory 1904. Frame 1902 may include movable struts or crossbars 1905 configured to slide from one end the frame to another end of the frame so that one or more images can be obtained of the inventory 1904 contained on the pallet 1906. FIGS. 19B and 19C provide top and side views of inventory count system 1900. System 1900 may include wheels 1907 and may include one or more actuators and robotic control systems to move from one pallet 1906 to another pallet contained in a warehouse.

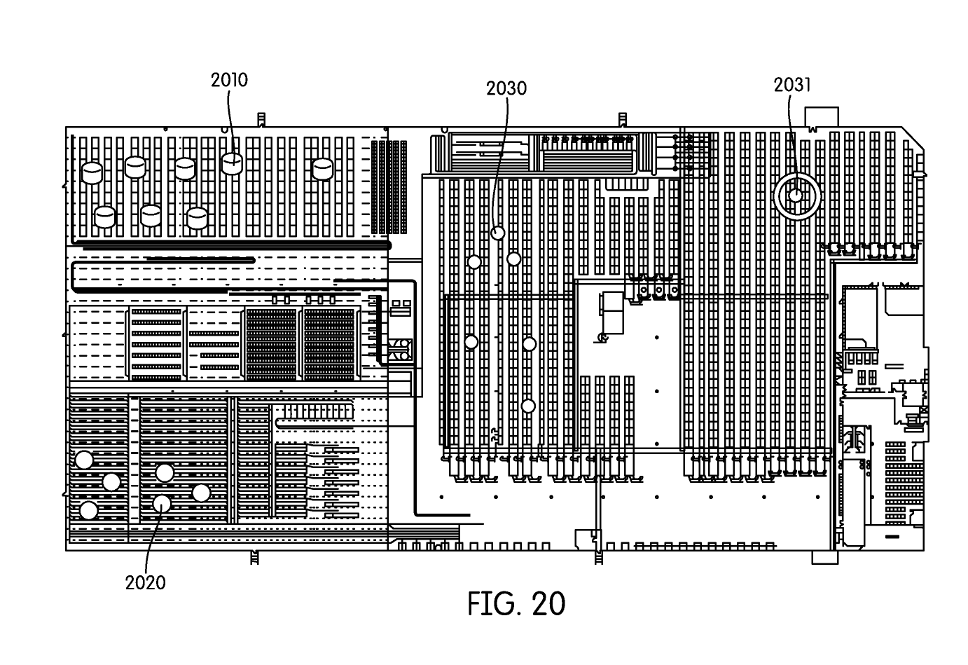

FIG. 20 provides a screen shot of an operations management systems implemented in accordance with illustrative embodiments. An operations management system, in accordance with various embodiments, monitors the movement of the users and reports the user location real time to a Warehouse Management System/Operations management System. This also facilitates further monitoring of users to ensure they stay within their confined working area as well as maintain the amount of distance travelled within the permissible range allowed for a specific role. The operations management system may be included as part of the enterprise system and may execute on one or more processors on a computing device (e.g., remote computer 104 of FIG. 1 or mobile device such as a Tablet). The operations management system may receive and transmit via a transceiver of the computing device data from mobile electronic device used by operators in the distribution center.

In the embodiment illustrated in FIG. 20, there are three groups of users 2010, 2010, 2020, and 2030 that are expected to be working confined within their area of work, but one user 2031 of group 2030 seems to be outside his working area, which could raise a flag to the warehouse manager.

The indoor GPS/positioning system enables real time location tracking of operators in the distribution center or warehouse. Various access points in the distribution center are identified and each mobile electronic device may be referenced based on the coordinates from the access points to determine the position of the mobile electronic point from the access points. In the Warehouse management systems/Operations Management systems that are in use today, users report their location by scanning the nearest location to them and often users don't walk to their nearest location but key enter a location from their memory, this creates errors in the labor movement data that is captured, whereas with the present device, users location can be fed to Operations Management systems real time.

The indoor GPS/positioning system enables warehouse managers to monitor operators within their confined working area using a graphical user interface. For example a Consumer goods DC might have three major zones, Kitchen, Office and Home goods zones. Operators are assigned work to keep themselves within a specific zone, so that their movement as minimal and time is spent on executing tasks instead of travelling from point A to point B. With a graphical dashboard like the one shown above leveraging the real time location capabilities with the present device, Warehouse managers are able to monitor operators real time for staying within their zones and hence efficient utilization of labor

The indoor GPS/positioning system enables warehouse managers to monitor the amount of distance travelled by operators. The distance travelled by operators is measured on a daily basis based on their role. For example a picker's daily travelled distance could be in the range of 10,000 feet to 12,000 feet, similarly a replenishment user's daily travelled distance could be in the range of 8,000 feet to 10,000 feet. Any other operator performing a similar role with distance travelled outside this range is a flag to analyze the nature of the job he is doing, as this could be an opportunity for improvement as he may be doing something wrong.

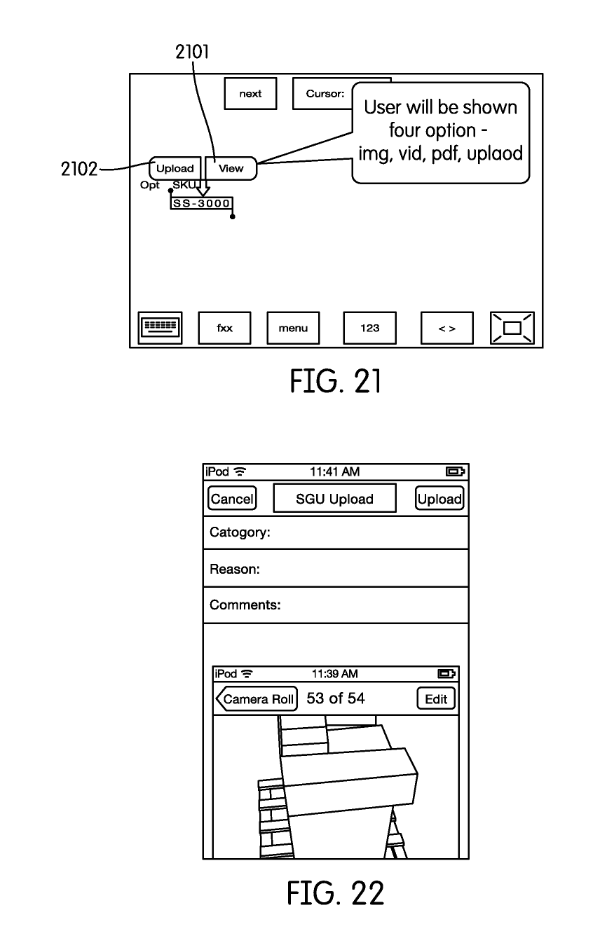

FIG. 21 provides a screen shot of an uploader application that permits viewing and uploading of pictures, videos and documents of entities or texts, which may be accessed once an image or video is captured as shown in FIG. 17C and selected as shown in FIG. 17D for uploading to an FTP site. The entities may include, but are not limited to, the starting item number of a product, a case number, a shipment number, a purchase order number, and a load number. The application may be used to view a picture or video or PDF document of the entity that is stored in the FTP server as well as to take a picture or video and upload it for an entity in FTP server. Once an item is selected, for example by text selection, the user is shown four options, in accordance with particular embodiments. The four options include the option to view a picture, vie a video, view a document, or upload. As demonstrated in FIG. 21, the view options may be selected via view option 2101 and the upload option may be selected via upload option 2102. In response to selecting view picture mode, the lookup application obtains the files from local cache, if the caching is enabled and the file exists in local cache, or the lookup application connects to the FTP server configured for View mode and looks for the files. In particular embodiments, the lookup application looks for the files in the following order:

1. PNG file with exact name as the text selected.

2. JPEG file with exact name as the text selected.

3. GIF file with exact name as the text selected.

4. PNG file with name that contains the text selected.

5. JPEG file with name that contains the text selected.

6. GIF file name that contains the text selected.

If there are multiple files matching any one criterion, then the latest file may be selected. After the picture file is selected, the lookup application downloads the image and displays it to the user in a separate window. The downloaded file may also be saved in local cache if the caching is enabled and space is available in local cache. The user may have the option to close the window and come back to the lookup application session to continue a transaction. In response to selecting view video mode, the lookup application obtains the files from local cache, if the caching is enabled and file exists in local cache, or the lookup application connects to the FTP server configured for View mode and look for the files. In particular embodiments, the lookup application looks for the files in the following order:

1. MP4 file with exact name as the text selected.

2. MP4 file name that contains the text selected.

If there are multiple files matching any one criterion, then the latest file may be selected. After the video file is selected, the lookup application downloads the video and displays it to the user in a separate window. The downloaded file may also be saved in local cache if the caching is enabled and space is available in local cache. The user may have the option to close the window and come back to the lookup application session to continue a transaction. In response to selecting view document mode, the lookup application obtains the files from local cache, if the caching is enabled and the file exists in local cache, or the lookup application connects to the FTP server configured for View mode and looks for the files. In particular embodiments, the lookup application looks for the files in the following order:

1. PDF file with exact name as the text selected.

2. PDF file name that contains the text selected.

If there are multiple files matching any one criterion, then the latest file may be selected. After the document file is selected, the lookup application downloads the document and displays it to the user in a separate window. The downloaded file may also be saved in local cache if the caching is enabled and space is available in local cache. The user may have the option to close the window and come back to the lookup application session to continue a transaction.

In response to selecting upload option 2102, the lookup application causes a display of the uploader interface illustrated in FIG. 22. The user will be able to capture photo or video using the camera of the device, such as the iPod Touch camera, and upload it to the FTP server configured for Upload. A picture or video and the associated data may be uploaded to the FTP server as two separate files.

FIG. 23 illustrates the management console application that may be used to configure the other application disclosed herein in accordance with particular embodiments. The management console application may be used system administrators responsible for monitoring the devices disclosed herein and the applications running thereon. The management console application may include computer-readable instructions and may execute, operate on, or otherwise run on one or more processors of a computing device (e.g., remote computer of FIG. 1). The management console application may receive and transmit data via input and output devices connected to the computing device, such as a transceiver, mouse, keyboard, microphone, headphones, touch sensitive display, and stylus, among others. The management console application may be deployed on a customer's network or it may be implemented by a cloud-based deployment. Using the management console application, a central user can manage and push configuration changes for to all devices managed by the management console application. Using the management console application, a central user can view and configure the devices that are registered with the management console application and view the configurations in the devices for every application managed by management console application. Once the configurations are created, the user of the management console application can publish a specific configuration or a group of configurations across multiple applications to one or multiple devices. The management console application 2300 can include two main components. The first component can include web-based tool 2301 used to create the configuration changes. The second component can include application changer 2302 that pushes the created configuration to the device to cause the application running on the connected devices to accept the configuration changes.

FIG. 24A shows the access screen for the management console application. The access screen provides a user interface for a user to enter a user I.D. and password.

FIG. 24B shows the main screen for the management console application that allows the user of the management console application to select devices, adjust configurations, and modify settings.

FIG. 24C demonstrates the user interface displayed in response to a user selecting devices on the main screen for the management console application. The user interface may list all of the configured devices and related information including, but not limited to, the device group, the device name, a device serial number, a device description, a device type, a device status, and a device update date. In particular embodiments, a user can click on the device name to view the aforementioned device details, as shown in FIG. 24D

FIG. 24E demonstrates the configuration interface displayed in response to a user selecting the configuration option on the main screen for the management console application. In particular embodiments, when a user selects an application or set of applications from the application option, the management console application pulls all configurations tied with the selected applications and display the information.

FIG. 24F shows the user interface displayed when a specific configuration is selected from the interface of FIG. 24E. The user may be permitted to edit the configuration, copy the detail, publish the configuration details, and unpublish the configuration details.

FIG. 24G shows the user interface displayed in response a publication request. The user interface of FIG. 24G permits the user to select the device or device group for receipt of the configuration. The user interface of FIG. 24G permits the user to select a date and time for publication and will proceed with the publication once the publish options is selected.

FIG. 24H is the user interface displayed in response the user selecting the settings options on the main screen shown in FIG. 24B. The settings user interface permits the management console user to perform maintenance on the console, to edit information, to add users, and to add new applications for management.

FIG. 24I shows the user interface displayed when a new user is added via the settings options produced via the display for FIG. 24H.

FIG. 24J shows the display screen where user will be able to view all the apps managed by the management console application and FIG. 24K shows the display screen that permits a user to add new applications or edit application to be managed using the management console application.

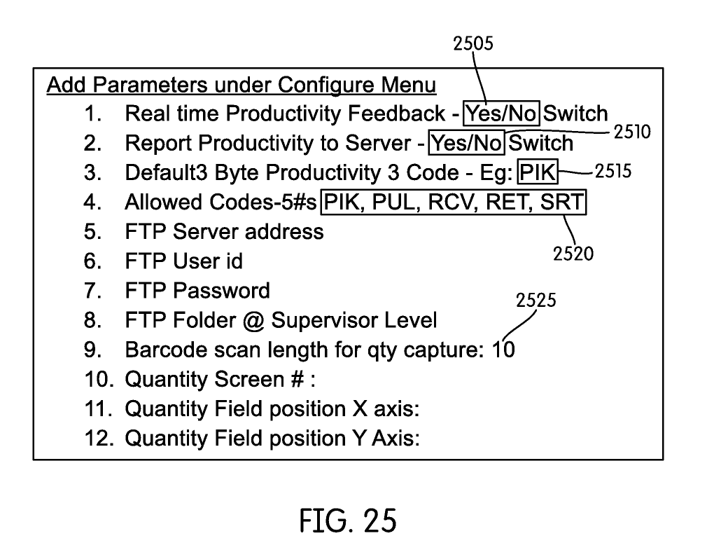

FIG. 25 shows the user interface for configuring an inventory capture session as managed by the management console application. The parameters used to configure the inventory capture session may include real-time productivity feedback, report productivity switch, byte productivity code, allowed codes, FTP serve address, FTP user identification, FTP password, FTP password, FTP folder, barcode scan length, quantity screen number, quantity field x-axis position, and quantity field y-axis position. The real-time productivity feedback 2505 may be used to set whether the productivity count is to be sent from the mobile electronic devices executing the terminal emulator application in near real-time. The report productivity switch 2510 may be used to set whether the productivity count is to be transmitted from the mobile electronic device executing the terminal emulator application. The byte productivity code field 2515 may indicate which one of the assignments, tasks, or projects the productivity count is to be associated with. The productivity field 2515 may be selected from one of the allowed byte productivity codes 2520. The barcode scan length 2525 may be used to specify the length of the barcode to be scanned by the mobile electronic device executing the terminal emulator application.

FIGS. 26A-F each show screenshots of inventory capture session interfaces displayed during a terminal emulation session on the mobile electronic device to the remote computer terminal progressing from FIG. 26A and ending with FIG. 26F. As depicted in FIG. 26A, the user interface engine executing on the mobile electronic device in conjunction with the terminal emulator application may display an initiation prompt 2602 in the form of a transparent box. Interaction with or activation of the initiation prompt 2602 may trigger a productivity counter executing on the mobile electronics device in conjunction with the terminal emulator application to initiate maintenance of a productivity count and a session timer as described above. As depicted in FIG. 26B, the user interface engine executing on the mobile electronic device in conjunction with the terminal emulator application may display a prompt 2604 including a byte productivity code field 2606, a star-yes button 2608, and a start-no button 2610. The byte productivity code field 2606 may be entered by interaction with the keyboard, such as the see through touch sensitive buttons described above but not shown. Upon interaction with or activation of the start-yes button 2608, the productivity counter executing on the mobile electronics device in conjunction with the terminal emulator application may start the session timer, accumulating number of units entered, calculate units per hour, and sends data including calculated units per hour to a remote computer (e.g., remote computer 104). The sending of data may cause the remote computer to keep track of the data by date, operator identifier, byte productivity code 2608, start time, and start time of the project or task associated with the byte productivity code 2608. The remote computer may create folders on a database maintained by the remote computer to keep track of the data based on the date, operator identifier, byte productivity code 2608, start time, and start time of the project or task associated with the byte productivity code 2608. Upon interaction with or activation of the start-yes button 2608, the productivity counter executing on the mobile electronics device in conjunction with the terminal emulator application may continue the functionalities of the terminal emulator application without initiating the productivity counter. FIG. 26C shows FIG. 26B with the see through touch sensitive buttons discussed in conjunction with FIGS. 12-16B.

Moving onto FIG. 26D, FIG. 26D illustrates the user interface of the terminal emulator application as the productivity counter maintaining the productivity count and the session timer. For example, whenever the mobile electronic device detects or scans an object, the productivity counter may update the productivity count and the session timer. The user interface may display the total time elapsed 2612, total units reported 2614, and the units per hour 2616, as well as the byte productivity code 2618. During the session, the productivity counter may continue to transmit the data to the remote computer. In various embodiments, the productivity counter may transmit the data at predefined intervals (e.g., every 3-90 minutes). FIG. 26E shows FIG. 26D with the see through touch sensitive buttons discussed in conjunction with FIGS. 12-16B and total time elapsed 2612, total units reported 2614, and the units per hour 2616, as well as the byte productivity code 2618 at a different position on the screen of the mobile electronic device. At the end of the inventory capture session, the user interface engine executing on the mobile electronics device in conjunction with the terminal emulator application may display a termination prompt 2604′ with a stop button 2620. Upon activation or interaction with the stop button 2620, the productivity counter executing on the mobile electronic device may stop the maintenance of the productivity counter. For example, the productivity counter may stop session timer, accumulating number of units entered, and calculation of units per hour. The productivity counter may also transmit the productivity count and related information to the remote computer.

FIGS. 27A-E illustrate screenshots of productivity rate tracking interfaces displayed on another computing device communicatively interfaced with the remote computer terminal. The other computing device (e.g., a tablet such as the iPad, Galaxy Tab, Surface Pro, or another mobile device similar to the mobile electronic device 101, or a large screen display including a smart television and associated platforms such as Apple TV, AirPlay, Android TV, Samsung TV, and LG TV, Sharp TV, among others) may be used to display and keep track of productivity metrics and rates of the mobile electronics device used to scan and detect objects for inventory management. Using the productivity count received from the productivity counter on the mobile electronic devices used to scan and detect objects, productivity metrics and rates may be calculated on the one or more processes of the computer device, the mobile devices (e.g., other mobile device 101), or the remote computer (e.g., remote computer 104), or any combination thereof. For example, a supervisor at an inventory management warehouse may use the computing device to download from the remote computer terminal the productivity metrics of operators that are using mobile electronic devices to scan objects at the warehouse. In various embodiments, multiple computing devices may be used to display the productivity metrics. For example, a tablet such as an iPad may be used to retrieve or obtain the productivity counts from various mobile electronic devices used to scan and detect objects and calculate the productivity metrics and rates. The tablet may then display the calculated productivity metrics and rates using one or more of the formats depicted in FIGS. 27A-E. In this example, the tablet may communicate with a large screen display such as an Apple TV, and using AirPlay stream and display the calculated productivity metrics and rates on the large screen display. The large screen display in this example may be placed, positioned, or otherwise located such that supervisors and operators of mobile electronic devices that are scanning objects at a warehouse may view their productivity metrics and rates and compare each operator's productivity metrics and rates with one another.

FIG. 27A depicts permissions, folders, and files for maintaining and categorizing the productivity counts and calculated productivity metrics. The productivity counts and calculated productivity metric may managed by a file management system operating on a remote computer (e.g., remote computer 104) and be stored on a database maintained by the enterprise system (e.g., database associated with remote computer 104). As depicted in FIG. 27A, the productivity count raw data files 2704 may be stored for each operator 2702 The raw data may include time and task that an operator started performing, time and task that the operate stopped performing, total units reported by the operator at sampled intervals, and units per hour reported by the operator at the sample intervals. The productivity counts and calculated productivity metric may be stored in operator level folders 2708 categorized by operator level 2706. The operator level folders may, for example, include all the productivity count and productivity metrics for the identified operator. The productivity counts and calculated productivity metric may also be stored in date level folders 2712 categorized by date or time 2710. For example, all the date level folders 2708 may be associated with data saved on Oct. 20, 2015. The productivity counts and calculated productivity metric may also be stored in supervisor-level folders 2716 categorized by supervisors 2714. The supervisor-level folders 2716 may include, for example, productivity counts and metric for operators working under a particular supervisor. Using this file categorization scheme, a supervisor, for example, at an inventory warehouse may be able to examine operator productivity data and time spent by operators on various projects, among others. For example, FIG. 27B shows a bar graph including various productivity measures such as picks per hour, total time, and total units by date. FIG. 26C shows a bar graph including various productivity measures such as picks per hour, total time, and total units by operator identifier for a single day. FIG. 27D shows a table including various productivity measures such as login time, start time, end time, total units, assignments for a particular operator identifier. FIG. 27E shows a bar graph including one productivity measure (picks per hour) by operator identifiers. These productivity measures may be displayed in graphical form on wearable devices, other computing devices, and large screens at inventory warehouses to inform viewers, such as operators and supervisors. Productivity measures may be color coded based on threshold cutoffs. For example, a bar graph for units per hour may be green if above 300 units per hour, yellow if between 270 units per hour and 300 units per hour, red, if below 270 units per hour.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

1. A mobile electronic device for terminal emulation comprising:
a touch screen display;
a transceiver that is in bi-directional wireless communication with an enterprise system running on a remote computer system; and
one or more processors that provide a user interface for display on the touch screen display via a terminal emulation application executing on the one or more processors, the user interface including:
first content received via the transceiver from the enterprise system running on the remote computer system;
second content including a productivity count; and
a touch sensitive button superimposed in a semi-transparent manner over the first content, the see through touch sensitive button providing a touch-sensitive key to send data to the remote computer responsive to activation while simultaneously continuing to display the first content received from the remote computer system on the touch screen display.

2. The mobile electronic device of claim 1, further comprising a capture device coupled to the one or more processors that detects or scans an object, the capture device including at least one of a scanner, an image capture device, a video capture device, or a RFID reader; and
wherein the one or more processors maintains a productivity counter updating the productivity count, responsive to the capture device detecting or scanning the object.

3. The mobile electronic device of claim 1, wherein the transceiver transmits the productivity count to the remote computer system for storage at a predefined time interval.

4. The mobile electronic device of claim 1, wherein the transceiver is in further bi-directional wireless communication with a computing device and transmits at a predefined time interval the productivity count to the computing device, causing the computing device to display the productivity count.

5. The mobile electronic device of claim 1, wherein the user interface further comprises:
an initiation dialog prompting an entry of an assignment identifier, the entry of the assignment identifier causing the one or more processors to start a tracking session to update the productivity count; and
a terminal dialog including a second touch-sensitive key, activation of the second touch-sensitive key causing the one or more processors to end the tracking session.

6. The mobile electronic device of claim 1, wherein the one or more processors maintain the productivity count categorized by a time interval, an assignment identifier, and an operator identifier.

7. The mobile electronic device of claim 1, wherein the productivity count comprises at least one of units per hour, total units reported, and a total time elapsed.

8. A system for terminal emulation, comprising:
a terminal emulation application executing on one or more processors of a mobile electronic device that receives via a transceiver first content from an enterprise system running on a remote computer system;
a productivity counter executing on the one or more processors of the mobile electronic device that maintains second content including a productivity counter;
a control button generator executing on the one or more processors of the mobile electronic device that generate a see through touch sensitive buttons for operating with the terminal emulation application;
an user interface engine executing on the one or more processors of the mobile electronic device that displays a user interface on a touchscreen display of the mobile electronic device, the user interface including:
the first content received by the terminal emulation application;
the second content including the productivity count maintained by the productivity counter; and
the see through touch sensitive button superimposed in a semi-transparent manner over the first content, the see through touch sensitive button providing a touch-sensitive key, the see through touch sensitive button providing a touch-sensitive key to send sending data to the remote computer system responsive to activation while simultaneously continuing to display the first content received from the remote computer system on the touch screen display.

9. The system of claim 8, wherein the productivity counter initiates the maintenance of the productivity count, responsive to an initiation command from a first activation of the user interface; and resets the productivity counter, responsive to a termination command from a second activation of the user interface.

10. The system of claim 9, wherein the productivity counter maintains a session timer to count a session time duration between receipt the initiation command and receipt of the termination command.

11. The system of claim 8, wherein the productivity counter transmits via the transceiver the productivity count to a computing device or the remote computer system, responsive to a request from the computing device.

12. The system of claim 8, further comprising:
a capture device that sends data to mobile electronic device responsive to scanning an object, the capture device including at least one of a scanner, an image capture device, a video capture device, or a RFID reader;
wherein the productivity counter updates the productivity count responsive to the capture device scanning the object.

13. The system of claim 8, wherein the productivity count comprises at least one of units per hour, total units reported, and a total time elapsed.

14. A system for configuring a mobile device for enterprise use, comprising:
an enterprise application executing on a remote computer system having one or more processors that maintains an inventory count;
an operations management module executing on the remote computer system that maintains a server-side productivity count in a database; and
an installation module executing on the remote computer system that transmits a terminal emulation application for installation at a mobile electronic device, the terminal emulation application causing the mobile electronics device to display a user interface including:
first content received from the remote computing system, including an emulated version of the enterprise application;
second content including a client-side productivity count maintained by the mobile electronic device; and
a see through touch sensitive button superimposed in a semi-transparent manner over the first content, the see through touch sensitive button providing a touch-sensitive key to send data to the remote computer system responsive to activation while simultaneously continuing to display the first content received from the remote computer system on the touch screen display.

15. The system of claim 14, wherein the operations management module:
receives the client-side productivity count from the mobile electronic device at a predefined time interval; and
sets the server-side productivity count to the client-side productivity count, responsive to receiving the client-side productivity count.

16. The system of claim 14, wherein the operations management module:
maintains the server-side productivity count categorized by a time interval, an assignment identifier, and an operator identifier; and
transmits the server-side productivity count categorized by the time interval, the assignment identifier, and the operator identifier to a computing device, receipt of the server-side productivity count causing the computing device to display the server-side productivity count thereon.

17. The system of claim 14, wherein the operations management module:
transmits the server-side productivity count and an operator identifier corresponding to the mobile electronic device to a computing device, receipt of the server-side productivity count causing the computing device to:
calculate a productivity metric based on the server-side productivity count for the operator identifier; and
display the productivity metric, responsive to calculating the productivity metric.

18. The system of claim 14, wherein the enterprise application updates the inventory count, responsive to receiving a client-side inventory count from the mobile electronic device.

19. The system of claim 14, wherein the server-side productivity count comprises at least one of units per hour, total units reported, and a total time elapsed.

20. The system of claim 14, wherein the operations management module:
receives the client-side productivity count from the mobile electronic device;
compares the client-side productivity count to an average client-side productivity count calculated over a plurality of client-side productivity counts;
transmits an alert indicator to the mobile electronic device or a computing device, responsive to determining that the client-side productivity count is below the average client-side productivity count by a predetermined threshold.
